(19) United States
(12) Patent Application Publication
(10) Pub. No.: US 2015/0272170 A1
(43) Pub. Date: Oct. 1, 2015

(54) FOAMING AGENT FOR USE IN FOOD COMPOSITIONS

(71) Applicants: Solae, LLC, St. Louis, MO (US); DuPont Nutrition Biosciences APS, Copenhagen (DK)

(72) Inventors: Zebin Wang, St. Louis, MO (US); Yeun S. Gu, St. Louis, MO (US); William C. Smith, St. Louis, MO (US); John A. Brown, St. Louis, MO (US); Finn Madsen, Brabrand (DK); Finn Hjort Christensen, Brabrand (DK)

(21) Appl. No.: 14/417,412

(22) PCT Filed: Jul. 26, 2013
(86) PCT No.: PCT/US2013/052407

§ 371 Date: Jan. 26, 2015

Related U.S. Application Data
(60) Provisional application No. 61/675,910, filed on Jul. 26, 2012.

(51) Int. Cl. A23L 1/00; A23G 9/38; A23G 9/46; A23L 2/66; A23G 3/44; A21D 13/00; A21D 13/08; A23J 3/16; A23G 3/52

(52) U.S. Cl. CPC A23L 1/0097; A23J 3/16; A23G 9/38; A23G 9/46; A23G 3/52; A23G 3/44; A21D 13/0093; A21D 13/08; A23L 2/66; A23V 2002/00

(57) ABSTRACT

A foaming agent comprising an amount of soy whey protein is disclosed herein, the soy whey protein having been isolated from processing streams. The foaming agent is especially suitable for producing a food product.

This application claims priority from U.S. Provisional Application Ser. No. 61/675,910 filed on Jul. 26, 2012, which is hereby incorporated by reference in its entirety.

### FIELD OF THE INVENTION

The present disclosure relates to a foaming agent for use in food products. Specifically, the foaming agent comprises an amount of soy whey protein having a SSI of at least about 80% across a pH range of from 2 to 10 and a temperature of 25° C.

### BACKGROUND OF THE INVENTION

Food scientists in the industry continually work to develop novel processes and resulting products that deliver improved nutritional and functional characteristics that consumers desire. The inclusion of soy protein is a cost-effective way to reduce fat, increase protein content and improve overall sensory characteristics of many food products.

Aerated food products are very popular. Foaming has become one of the fastest growing food processing operations for the development of new innovative products. Air is incorporated in the form of fine bubbles in order to render texture and mouthfeel to these products. Aeration can also help in mastication and enhance flavor delivery. The most commonly used aerated dairy products are ice cream, sorbets, whipped cream and mousses. Milkshakes, beer, sparkling wine, carbonated drinks and espressos/cappuccinos are examples of some aerated products. Aeration is also employed in several other food products such as bread, cakes, whipped topping, and meringue.

A foaming agent is a material that facilitates the formation of a stable air in liquid suspension in a mixture. The liquids can include water and/or oil. Foamability is the capacity of a foaming agent to incorporate air into liquid. A foaming agent will exhibit good foamability if it rapidly adsorbs onto the air-water interface. Most foaming agents typically used in the art exhibit good foamability because they work to lower the surface tension of water, which is also the goal of foaming agents. Foaming agents typically used in the art are low molecular weight compounds (such as small molecular surfactants), which are normally less than about 10 kilodaltons (kDa). Smaller compounds typically have good foamability because they have a high surface activity and are able to lower the surface tension of water better and more rapidly than high molecular weight compounds.

Foam stability refers to the rate of a foam to lose liquid and/or the breakup of gas bubbles. High molecular weight compounds, including proteins (such as albumen proteins found in egg whites) are commonly used as foam stabilizers because the proteins unfold and align themselves at the liquid-gas interface of the bubbles reinforcing the bubble walls. High molecular weight compounds, for example, mild hydrolyzed keratin, unfold in the liquid-air interface once they are adsorbed onto the interface and form inter-molecular bonds, which results in stable film to prevent gas bubbles from breaking up. However, because of the high molecular weight, it is difficult for the molecules to adsorb onto the liquid-air interface, therefore the foamability is poor. If the high molecular proteins are highly hydrolyzed, the resulting small molecular fragments will behave like other small molecular surface active compounds. That is, the molecules may easily adsorb into the liquid-air interface thus exhibiting high surface activity and good foamablity, but unable to form stable film, which greatly reduce foam stability.

Foaming agents, such as surfactants, are routinely added to various food products to provide foam forming capability. Examples of commonly known foaming agents having low molecular weight that are typically used in the art include, but are not limited to, mono- and diglycerides of fatty acids, esters of monoglycerides of fatty acids, propylene glycol monoesters, lecithin, hydroxylated lecithin, dioctyl sodium sulphosuccinate, sodium stearoyl-2-lactylate (SSL), calcium stearoyl lactylate (CSL), sorbitan monolaurate (Polysorbate 20 or Tween20), sorbitan monopalmitate (Polysorbate 40 or Tween40), sorbitan monostearate (Polysorbate 60 or Tween60), sorbitan monooleate (Polysorbate or Tween80), sorbitan tristearate, stearyl citrate, and polyglycerol polyricinoleate (PGPR). These commonly used foaming agents are known to produce the desired characteristics of a food product.

Some proteins, other than soy whey protein, are known to enable stability of foams these include albumin, gluten, casein, caseinate, and dairy whey protein. These proteins are frequently formulated in conjunction with the small molecular weight foaming agents listed above. The food products using these foaming agents are typically in a pH range of 6.0 to 8.0. However, these proteins other than soy whey protein do not work well as foaming agents in the acid pH range (3.5-5.5). Other protein-based foaming agents (e.g., isolated soy protein (ISP) foaming agents) are not currently used in the industry since they have not been found to impart characteristics desired by the consumer. Therefore, it would be desirable to use soy protein-based foaming agents in conjunction with or as a replacement for commonly used foaming agents in order to provide nutritional and functional benefits to food products.

An ideal foaming agent would be one that has a high surface activity to provide good foamability but also provides long-term foam stability. Small molecular weight surfactants have high surface activity, thereby providing good foamability, but fail to provide long-term foam stability. High molecular weight biopolymers, such as globular proteins other than soy whey protein and carbohydrates, have low surface activity, which does not promote good foamability, but they can provide long-term foam stability.

Thus, there is a need in the art for a food-grade foaming agent that contains a protein-based substance and that provides both good foamability and long-term foam stability. The foaming agent can further impart to food products an amount of protein and overall nutritional profile desired by a consumer. Accordingly, the present invention is directed to a foaming agent comprised in whole or in part of soy whey protein for use in a food product, thereby eliminating or reducing the need to additionally add a second foaming agent to the food product.

### SUMMARY OF THE INVENTION

The present disclosure relates to a foaming agent for use in food products. Specifically, the foaming agent comprises an amount of soy whey protein having a SSI of at least about 80% across a pH range of from 2 to 10 and a temperature of 25° C. The inclusion of soy whey protein as a foaming agent acts to provide long-term foamability for the food products and produces a food product having sensory properties (i.e., taste, structure, aroma and mouthfeel) desired by consumers when compared to similar food products currently on the market containing other foaming agents.

The present disclosure further relates to food products that contain a foaming agent comprising an amount of soy whey protein having a SSI of at least about 80% across a pH range of from 2 to 10 and a temperature of 25° C. The foaming agent disclosed herein is suitable for use in the preparation of various types of food products that require some degree of aeration, for example, whipped toppings, baked dessert products (such as meringues, cakes, etc.), beverages (such as cappuccino foam, and alcoholic beverages such as beer and sparkling wine), confections, frozen confections or frozen desserts (such as sorbet and ice cream), soups, sauces, and the like.

The present disclosure further relates to a method of making a food product, the method comprising combining a foaming agent with water and/or other ingredients to form an aerated mixture and processing the aerated mixture into the desired food product, wherein the foaming agent comprises an amount of soy whey protein having been recovered from a processing stream and having a SSI of at least about 80% across a pH range of from 2 to 10 and a temperature of 25° C.

### Reference to Color Figures

The application contains at least one photograph executed in color. Copies of this patent application publication with color photographs will be provided by the Office upon request and payment of the necessary fee.

### BRIEF DESCRIPTION OF THE DRAWINGS

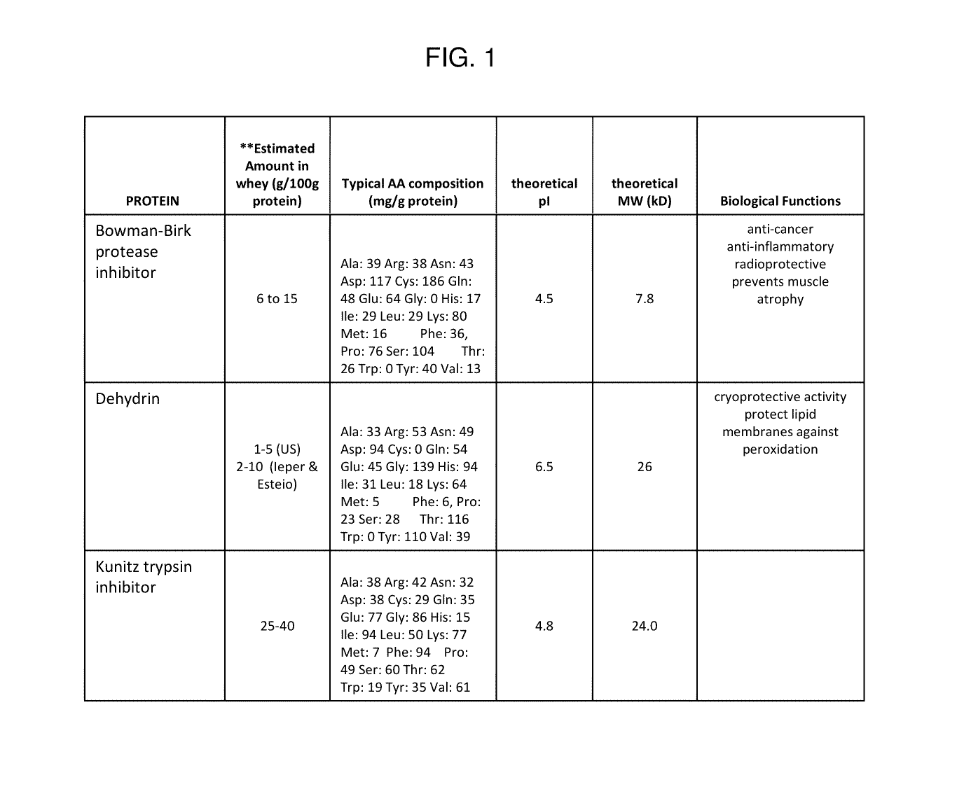

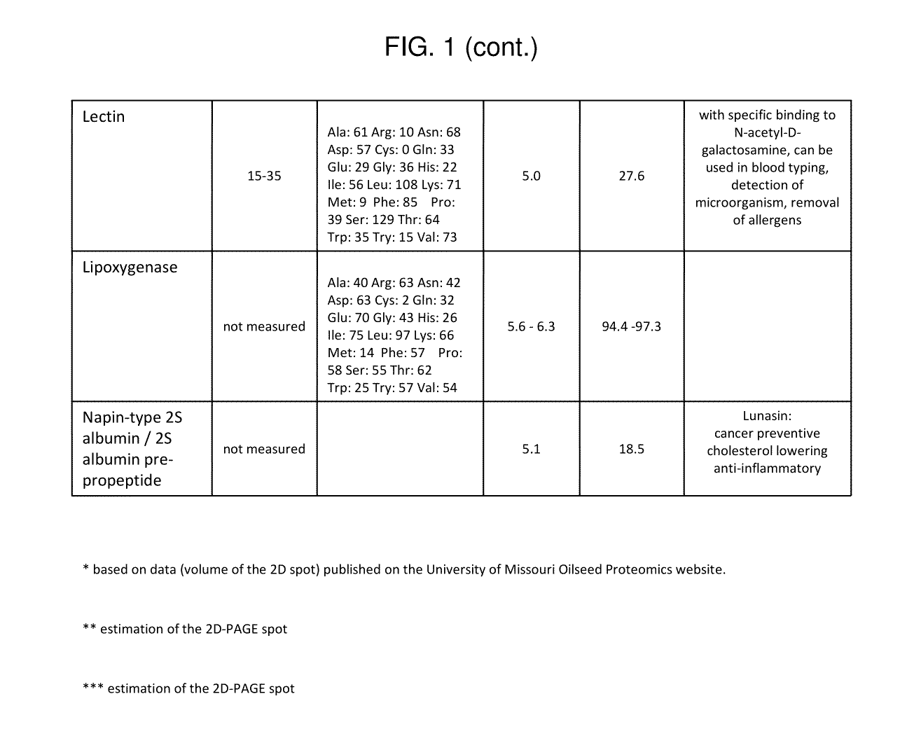

FIG. 1 is a chart setting forth the proteins found in soy whey streams and their characteristics.

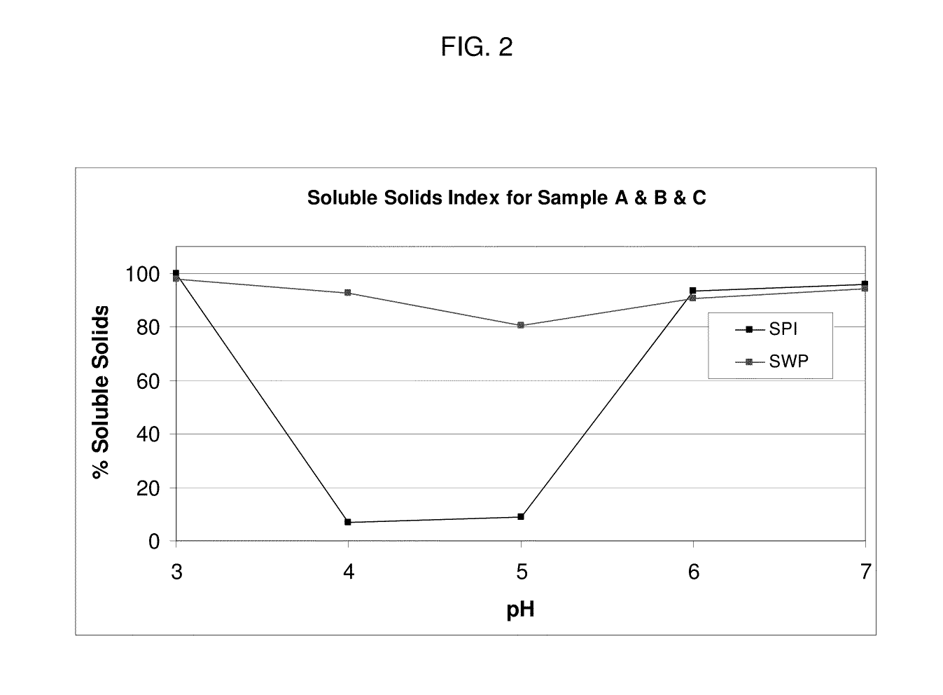

FIG. 2 graphically depicts the solubility of the soy whey proteins over a pH range of 3-7 as compared to that of soy protein isolates.

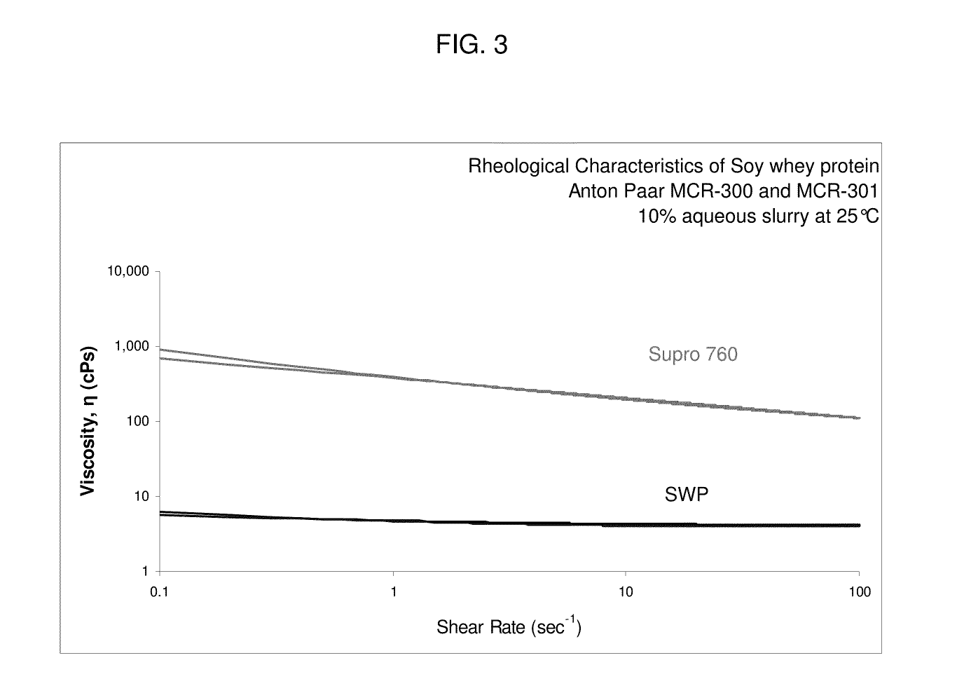

FIG. 3 graphically depicts the rheological properties of the soy whey proteins compared to soy protein isolate, Supro® 760.

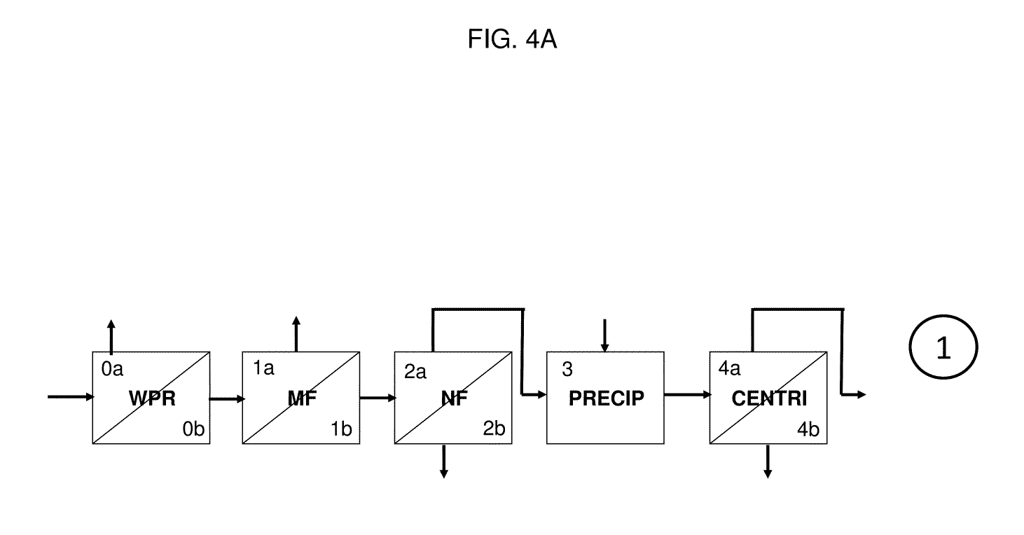

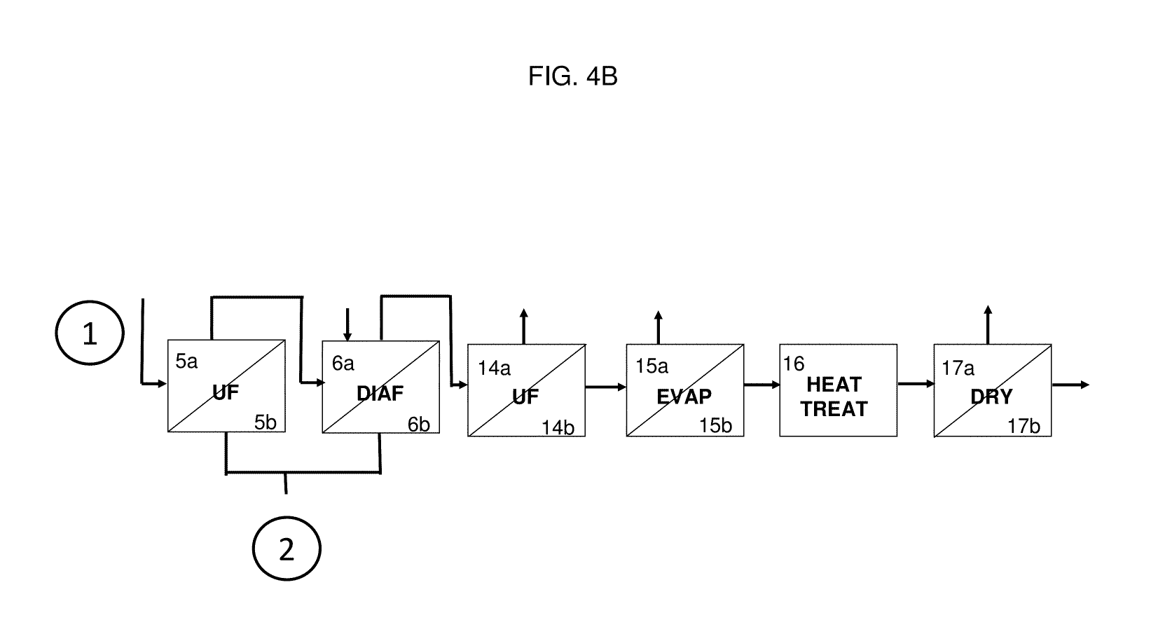

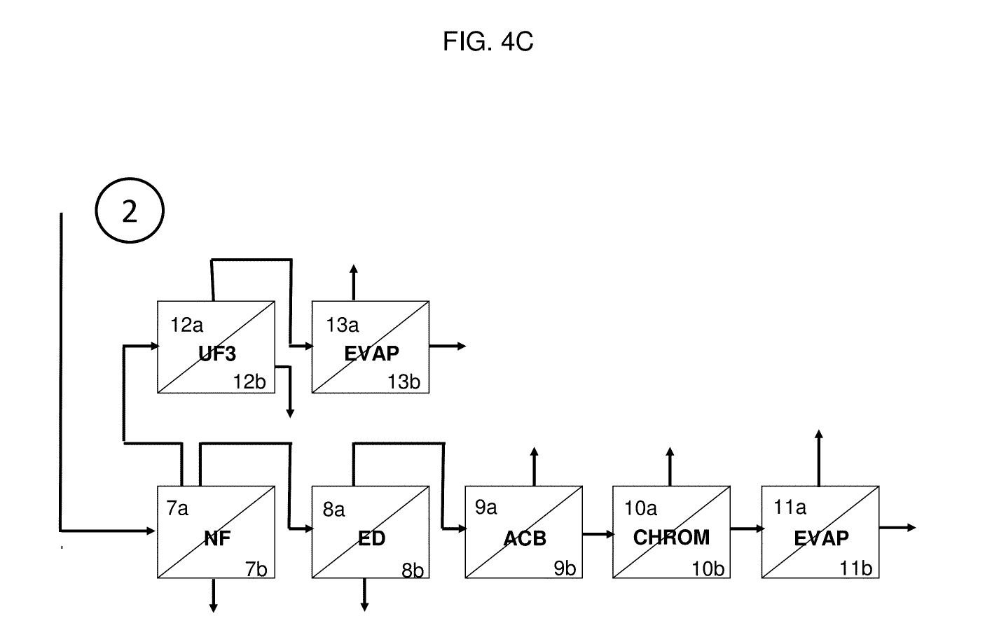

FIG. 4A is a schematic flow sheet depicting Steps 0 through 4 in a process for recovery of a purified soy whey protein from processing stream.

FIG. 4B is a schematic flow sheet depicting Steps 5, 6, 14, 15, 16, and 17 in a process for recovery of a purified soy whey protein from processing stream.

FIG. 4C is a schematic flow sheet depicting Steps 7 through 13 in a process for recovery of a purified soy whey protein from processing stream.

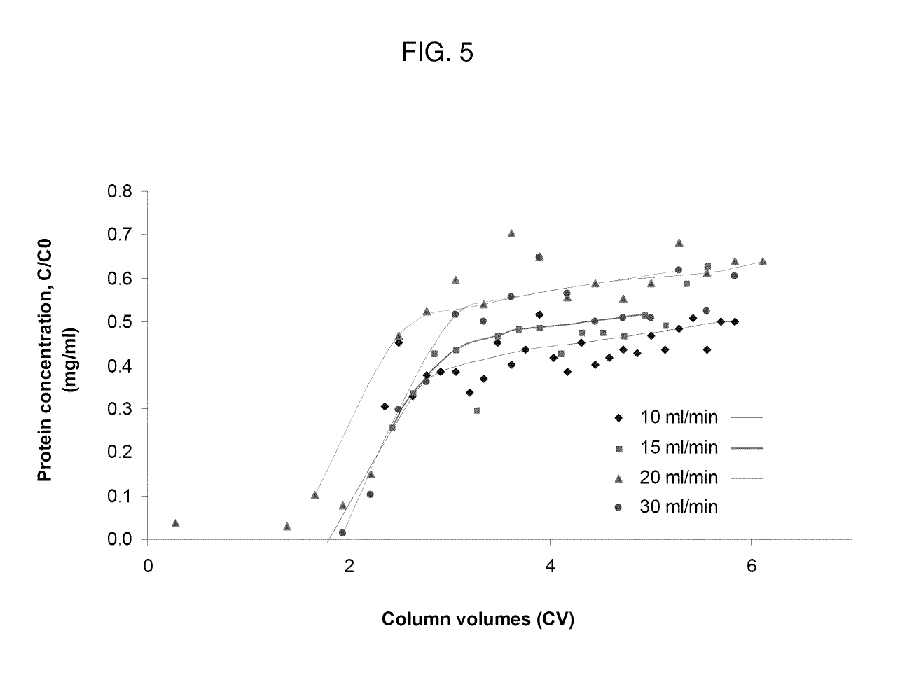

FIG. 5 graphically illustrates the breakthrough curve when loading soy whey at 10, 15, 20 and 30 mL/min (5.7, 8.5, 11.3, 17.0 cm/min linear flow rate, respectively) through a SP Gibco cation exchange resin bed plotted against empty column volumes loaded.

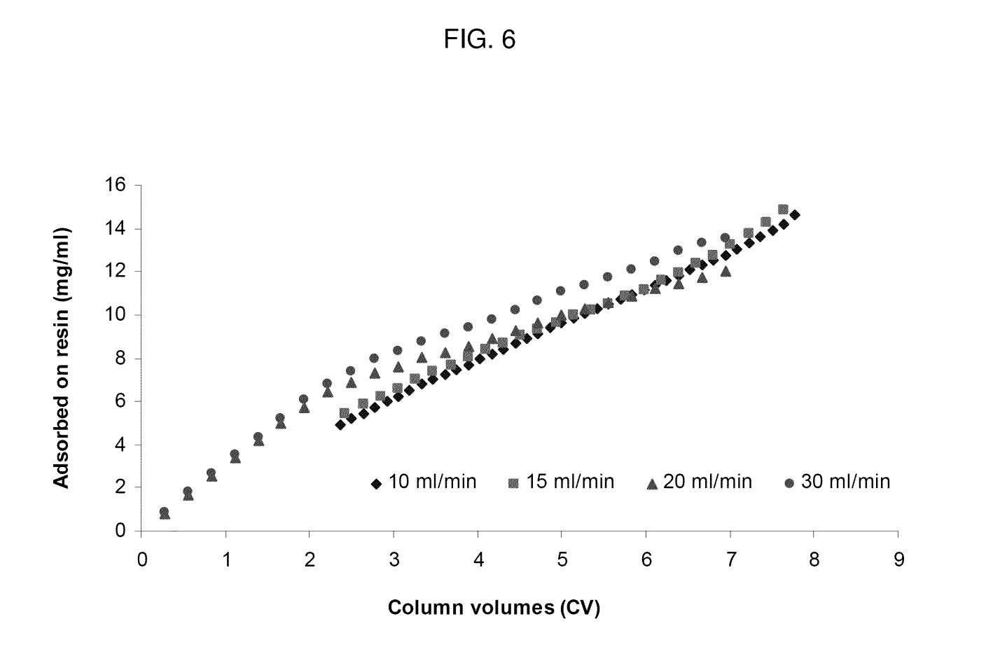

FIG. 6 graphically illustrates protein adsorption on SP Gibco cation exchange resin when passing soy whey at 10, 15, 20 and 30 mL/min (5.7, 8.5, 11.3, 17.0 cm/min linear flow rate, respectively) plotted against empty column volumes loaded.

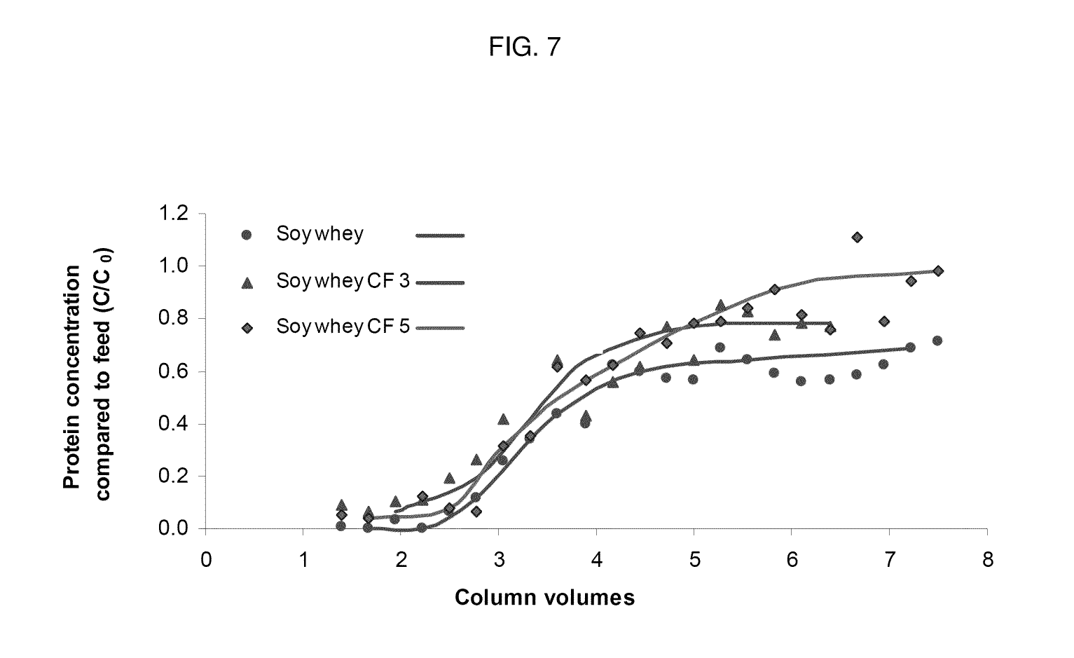

FIG. 7 graphically illustrates the breakthrough curve when loading soy whey at 15 mL/min and soy whey concentrated by a factor of 3 and 5 through SP Gibco cation exchange resin bed plotted against empty column volumes loaded.

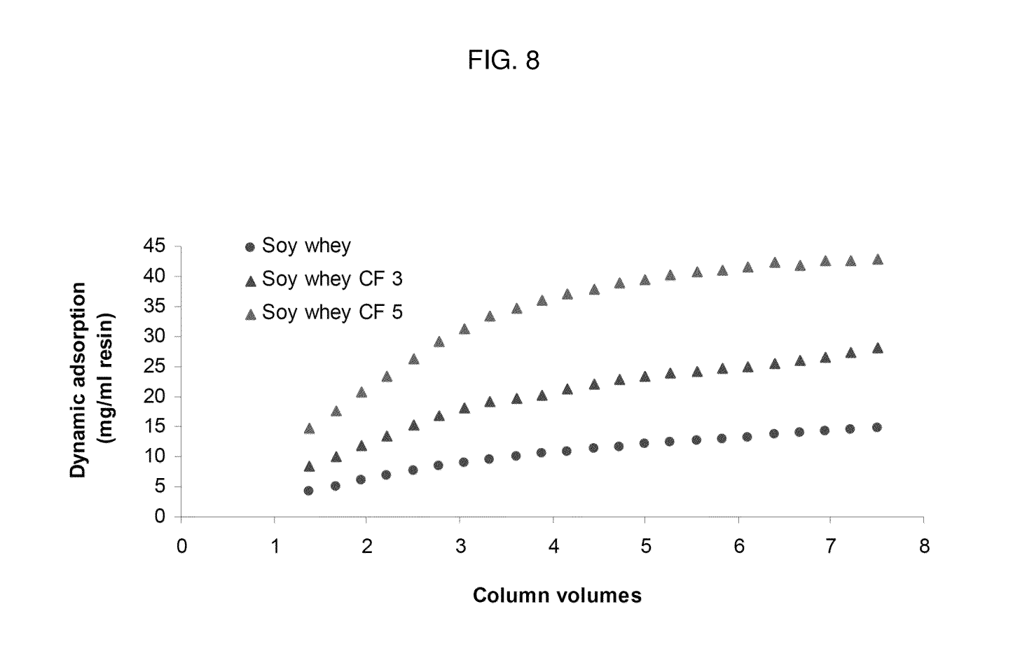

FIG. 8 graphically illustrates protein adsorption on SP Gibco cation exchange resin when passing soy whey and soy whey concentrated by a factor of 3 and 5 at 15 mL/min through SP Gibco cation exchange resin bed plotted against empty column volumes loaded.

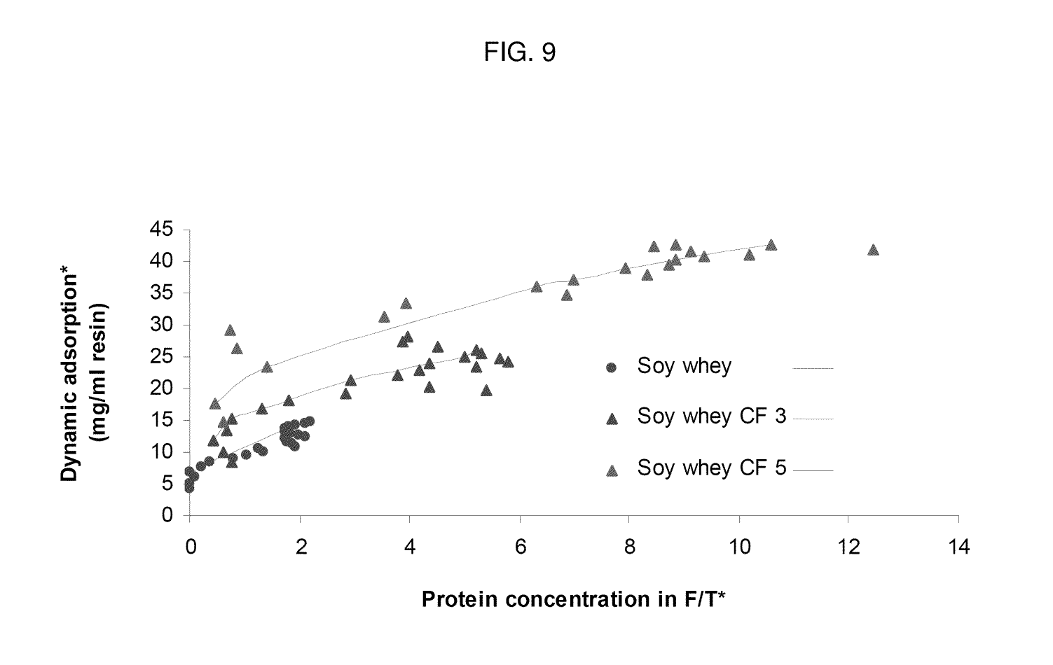

FIG. 9 graphically depicts equilibrium protein adsorption on SP Gibco cation exchange resin when passing soy whey and soy whey concentrated by a factor of 3 and 5 at 15 mL/min through SP Gibco cation exchange resin bed plotted against equilibrium protein concentration in the flow through.

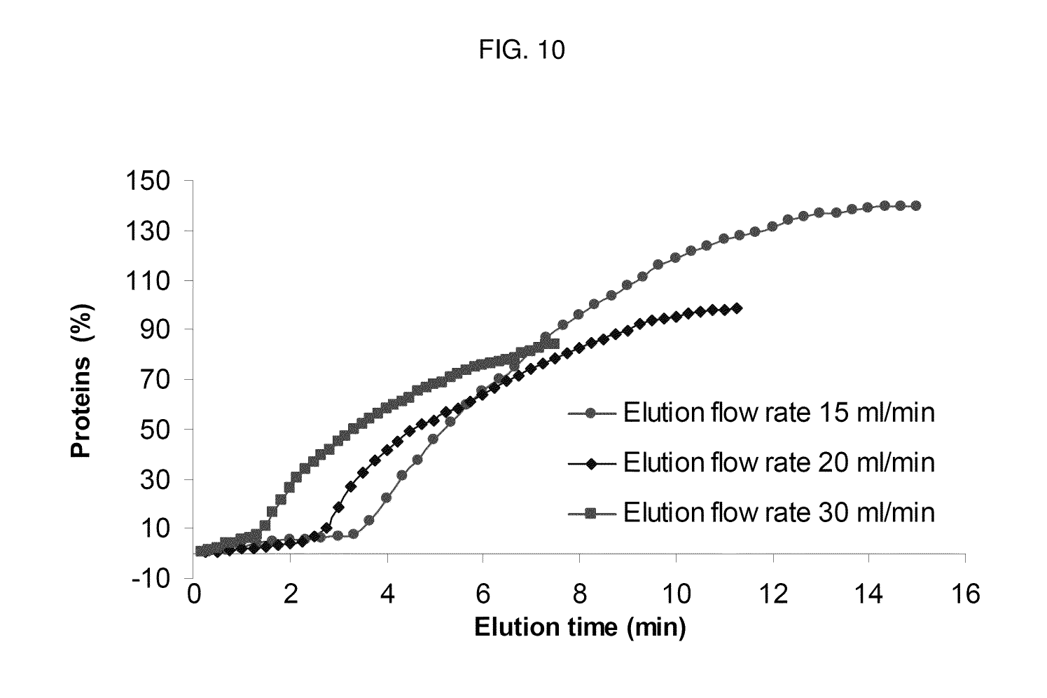

FIG. 10 graphically illustrates the elution profiles of soy whey proteins desorbed with varying linear velocities over time.

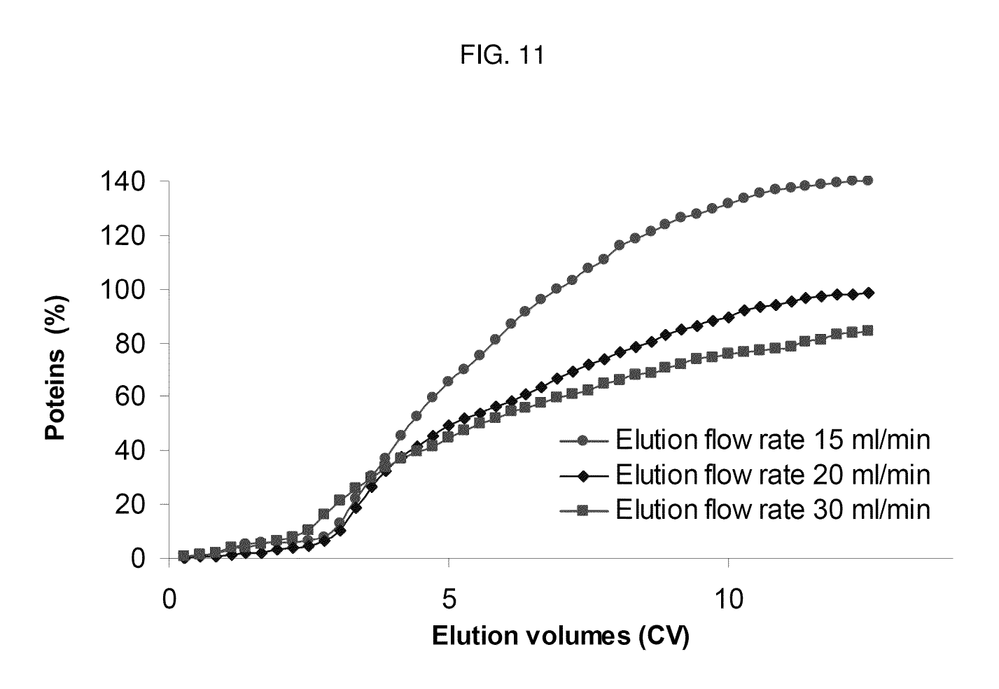

FIG. 11 graphically illustrates the elution profiles of soy whey proteins desorbed with varying linear velocities with column volumes.

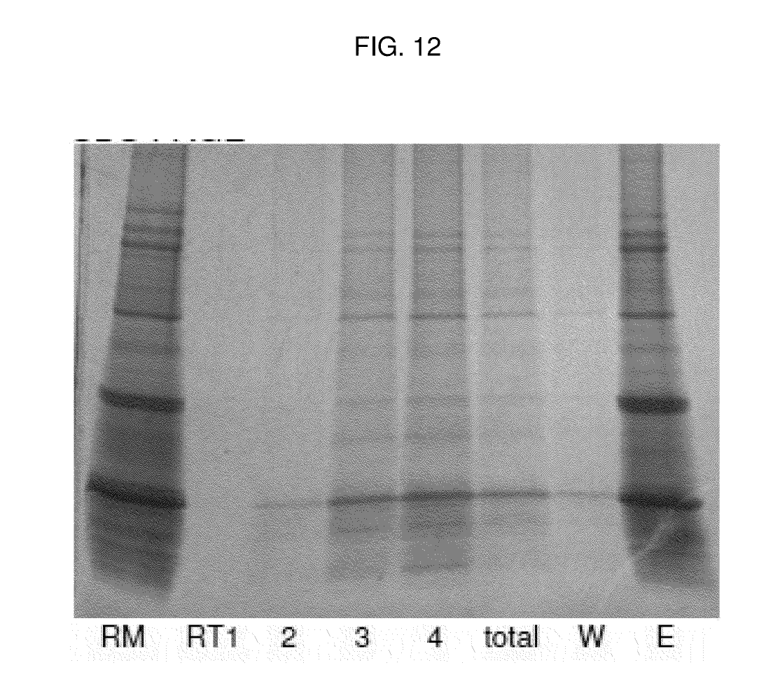

FIG. 12 depicts a sodium dodecyl sulfate polyacrylamide gel electrophoresis (SDS-PAGE) analysis of Mimo6ME fractions.

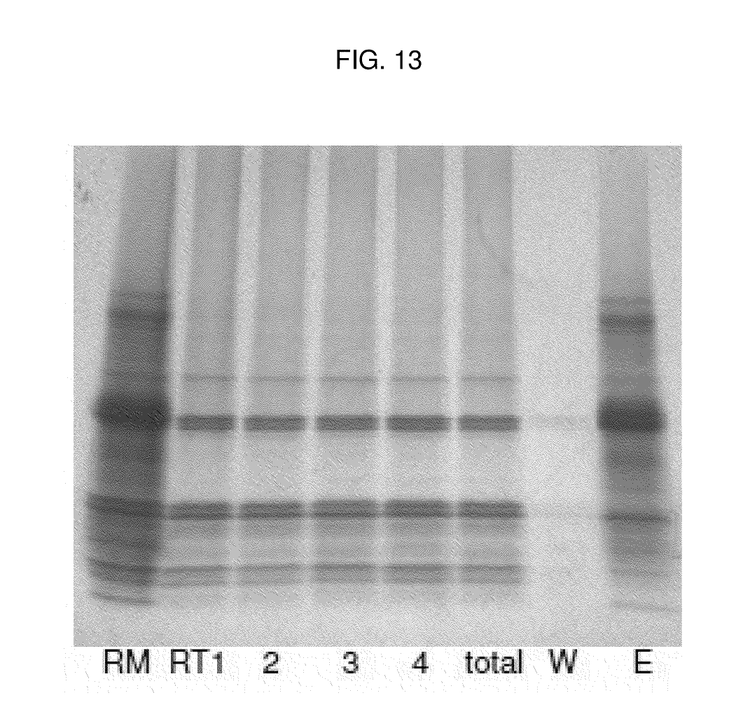

FIG. 13 depicts a SDS-PAGE analysis of Mimo4SE fractions.

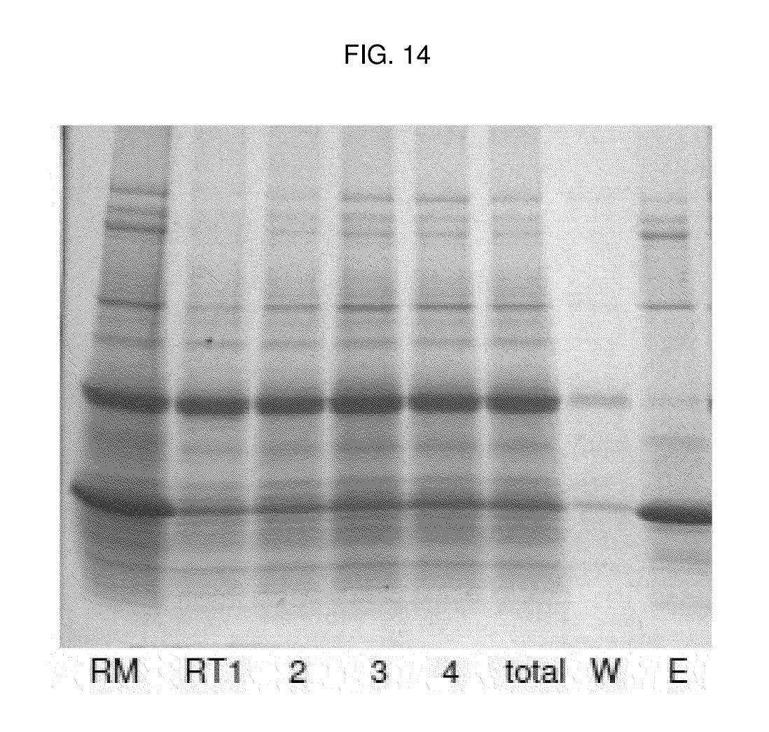

FIG. 14 depicts a SDS-PAGE analysis of Mimo6HE fractions.

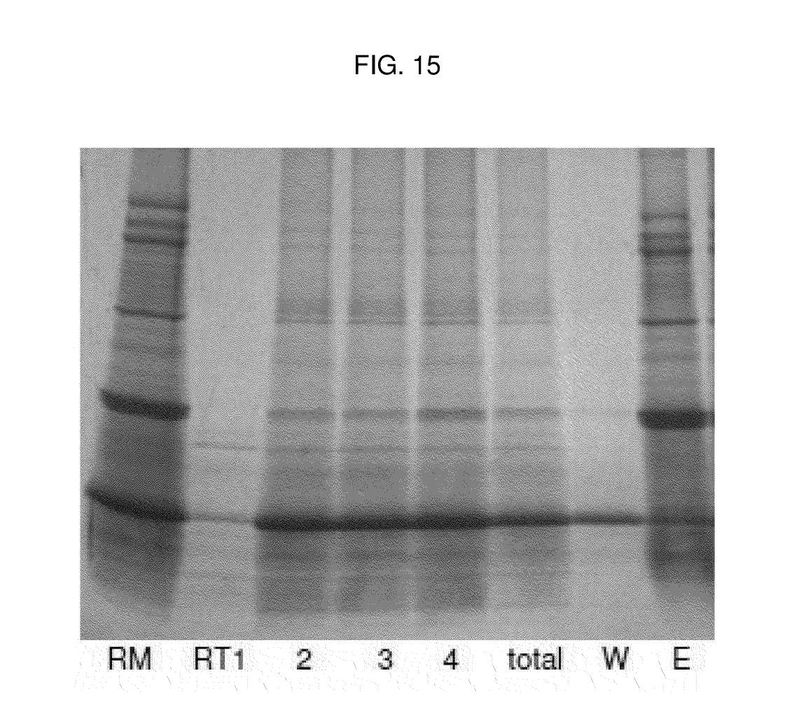

FIG. 15 depicts a SDS-PAGE analysis of Mimo6ZE fractions.

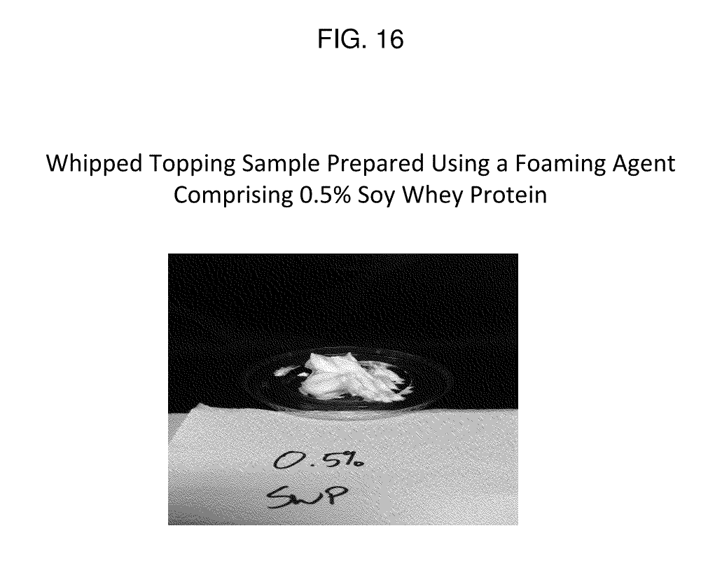

FIG. 16 is a photograph of a whipped topping sample prepared with a foaming agent comprising 0.5% soy whey protein.

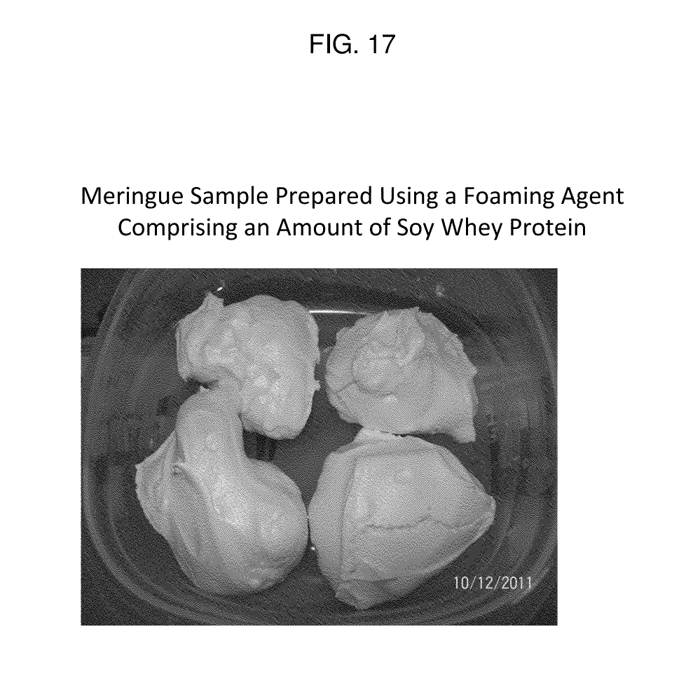

FIG. 17 is a photograph of meringue sample prepared with a foaming agent comprising an amount of soy whey protein.

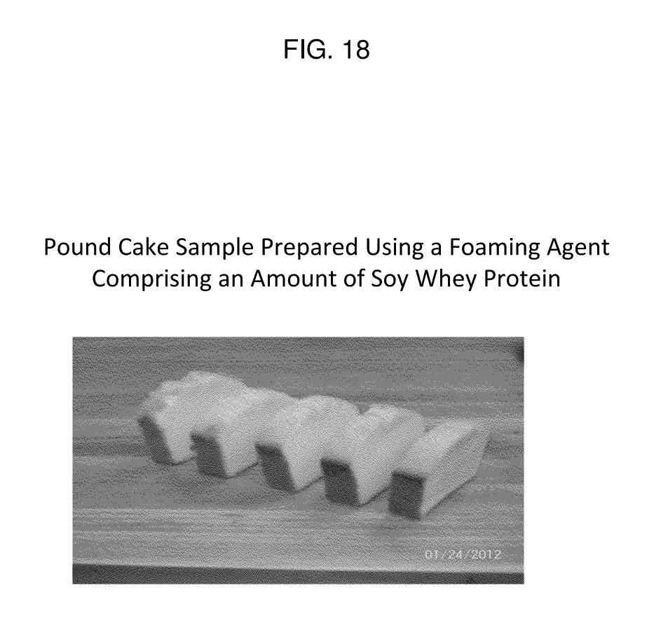

FIG. 18 is a photograph of a pound cake sample prepared with a foaming agent comprising an amount of soy whey protein.

### DETAILED DESCRIPTION OF THE PREFERRED ASPECTS

The present invention provides a foaming agent comprising an amount of soy whey protein having a SSI of at least about 80% across a pH range of from 2 to 10 and a temperature of 25° C. The foaming agent, when added to food products, imparts an improved nutritional and functional profile, and sensory properties (i.e., taste, structure, aroma, and mouthfeel) desired by consumers when comparing the resultant products to similar food products in the market which contain commonly used foaming agents.

### I. Foaming Agent

The foaming agent of the present invention for use in food products contains an amount of soy whey protein having a SSI of at least about 80% across a pH range of from 2 to 10 and a temperature of 25° C.

The soy whey proteins of the present invention have been discovered to impart superior foaming properties (i.e., foamability and foam stability) when used in food compositions over foaming agents currently used in the art under acidic pH ranges such as 2.0 to 5.5 or in another embodiment 3.0-5.5. Soy whey proteins as foaming agents perform nicely at building and stabilizing foam at lower pH, such as a pH of 4. Soy whey protein is shown in Example 13, below to whip/foam to 100% overrun in sorbet with flavours and no fruit puree at dosages down to 0.05%, and furthermore surprisingly was able to foam to 100% overrun in sorbet recipes with mango puree, which has until now not been possible with other foaming agents. Mango puree and other fruit purees including but not limited to raspberry puree, strawberry puree, and papaya puree are known to be extremely difficult to foam due to their content of specific surface active components, e.g. terpenes. Proteins other than soy whey protein have not been able to do this. Additionally, within the pH range (6.0-8.0) of many existing food applications soy whey proteins can enable comparable performance as a foaming agent. Soy whey proteins are high molecular weight compounds (e.g., about 8 kDa to about 50 kDa), and possess the desired characteristics of both small molecular weight foaming agents and large molecular weight foaming agents. Specifically, since the soy whey proteins have a higher molecular weight they are able to provide long-term foam stability but behave as small molecular weight compounds (i.e., good foamability) in that they promote rapid reduction in surface tension.

In one embodiment, the foaming agent of the present invention contains 100% soy whey protein. In another embodiment, the foaming agent contains a combination of soy whey protein and at least one additional foaming agent. For instance, the foaming agent may comprise soy whey protein and at least one additional foaming agent selected from the group consisting of mono- and diglycerides of fatty acids, esters of monoglycerides of fatty acids, propylene glycol monoesters, lecithin, hydroxylated lecithin, dioctyl sodium sulphosuccinate, sodium stearoyl-2-lactylate (SSL), calcium stearoyl lactylate CSL, Polysorbate 20, Polysorbate 40, Polysorbate 60, Polysorbate 80, sorbitan tristearate, stearyl citrate, PGPR, albumin, gluten, casein, caseinate, dairy whey protein, and combinations thereof. For example, the foaming agent may contain between about 5% to about 99.9% (w/w) of soy whey protein. Specifically, the foaming agent of the present invention may contain about 5%, 10%, 15%, 20%, 25%, 30%, 35%, 40%, 45%, 50%, 55%, 60%, 65%, 70%, 75%, 80%, 85%, 90%, 95%, 96%, 97%, 98%, 98.5%, 99%, 99.5%, 99.6%, 99.7%, 99.8%, or 99.9% (w/w) of soy whey protein for use in a food product. As shown in Example 13, below, in one embodiment the soy whey protein is combined with SSL to obtain superior results.

In an additional embodiment, the foaming agent of the present invention may further act as a stabilizing agent.

### II. Soy Whey Proteins

The soy whey proteins of the present disclosure represent a significant advance in the art over other soy proteins and isolates. As noted herein, the soy whey proteins of the present disclosure possess unique characteristics as compared to other soy proteins found in the art.

Soy protein isolates are typically precipitated from an aqueous extract of defatted soy flakes or soy flour at the isoelectric point of soy storage proteins (e.g. a pH of about 4.5±0.5). Thus, soy protein isolates generally include proteins that are not soluble in acidic liquid media. Similarly, the proteins of soy protein concentrates, the second-most refined soy protein material, are likewise generally not soluble in acidic liquid media. However, soy whey proteins of the present disclosure differ in that they are generally acid-soluble, meaning they are soluble in acidic liquid media.

The present disclosure provides soy whey protein compositions derived from an aqueous soy whey that exhibit advantageous characteristics over soy proteins found in the prior art.

A. High Solubility

The soy whey proteins isolated according to the methods of the present invention possess high solubility (i.e. SSI % greater than 80) across a relatively wide pH range of the aqueous (typically acidic) medium (e.g. an aqueous medium having a pH of from about 2 to about 10, from about 2 to about 7, or from about 2 to about 6) at ambient conditions (e.g. a temperature of about 25° C.). As shown in Table 1 and graphically illustrated in FIG. 2, the solubility of the soy whey proteins isolated in accordance with the methods of the present disclosure, at all pH values tested, was at least 80%, and in all but one instance (i.e. pH 4) was at least about 90%. These findings were compared with soy protein isolate, which was shown to display poor solubility characteristics at the same acid pH values. This unique characteristic enables the soy whey proteins of the present invention to be used in applications having acidic pH levels, which represents a significant advantage over soy isolate.

B. Low Viscosity

In addition to solubility, the soy whey proteins of the present disclosure also possess much lower viscosity than other soy proteins. As shown in Table 1 and as graphically illustrated in FIG. 3, the soy whey proteins of the present invention displayed viscoelastic properties (i.e. rheological properties) more similar to that of water than shown by soy protein isolate. The viscosity of water is about 1 centipoise (cP) at 20° C. The soy whey proteins of the present disclosure were found to exhibit viscosity within the range of from about 2.0 to 10.0 cP, and preferably from about 3.6 to 7.5 cP. This low viscosity, in addition to its high solubility at acidic pH levels, makes the soy whey protein of the present disclosure available and better suited for use in certain applications that regularly involve the use of other soy proteins (e.g., in food products), because it has much better flow characteristics than that of soy isolate.

TABLE 1
Solubility and Viscoelastic Properties of Soy Whey Compared to a
Commercial Isolated Soy Protein

| | SWP | Supro 500E |
|---|---|---|
| SSI %, pH 3.0 | 99 | 100 |
| SSI %, pH 4.0 | 82.3 | 7 |
| SSI %, pH 5.0 | 89.4 | 9 |
| SSI %, pH 6.0 | 99.3 | 94 |
| SSI %, pH 7.0 | 99.4 | 96 |
| Viscosity*, cPs | 4.3 | 5700-7100 |

*Viscosity was measured on isolate in water slurries at as is pH. Concentration at 10% w/w (weight isolate/total sample weight). Temperature at 25° C. Shear rate was 1 1/s (second).

As Table 2 illustrates, the other physical characteristics, with the exception of the viscoelastic properties and solubility, of the soy whey protein recovered in accordance with the methods of the present disclosure were found to be very similar to that of soy isolate.

TABLE 2
Physical Characteristic Ranges of Soy Whey Proteins from Two
Plant Sites

| | ranges, | | combined |
|---|---|---|---|
| | leper | ranges, St. Louis | SWP range |
| moisture | 2.94-9.34 | 3.91-8.29 | 2.9-9.4 |
| protein_db | 71.0-89.3 | 62.48-85.17 | 62.4-89.3 |
| ash_db | 1.19-6.23 | 1.19-13.57 | 1.19-13.57 |
| fat_db | 0.201-1.11 | 0.14-1.57 | 0.14-1.57 |
| carbohydrate by | 7.2-23.7 | 5.4-30.5 | 5.4-30.5 |
| diff_db | (10 & 20 kDa | | |
| | membrane) | | |
| | | | combined |
| | leper SWP | St. Louis SWP | range |
| SSI %, pH 3.0 | 79-99 | 71.6-100‘ | 71-100 |
| SSI %, pH 4.0 | 68.7-97.3 | 67.4-94.7 | 67-98 |
| SSI %, pH 5.0 | 70.4-88.9 | 69.4-91.5 | 69-92 |
| SSI %, pH 6.0 | 79.1-93.49 | 75.1-100 | 75-100 |
| SSI %, pH 7.0 | 77.6-97.2 | 79.6-100 | 77-100 |
| viscosity, cPs | 3.6-7.5 | 3.3 (1 sample | 3.3-7.5 |
| | | only) | |

### III. Aqueous Whey Streams

Aqueous whey streams and molasses streams, which are types of soy processing streams, are generated from the process of refining a whole legume or oilseed. The whole legume or oilseed may be derived from a variety of suitable plants. By way of non-limiting example, suitable plants include leguminous plants, including for example, soybeans, corn, peas, canola, sunflowers, sorghum, rice, amaranth, potato, tapioca, arrowroot, canna, lupin, rape, wheat, oats, rye, barley, and mixtures thereof. In one embodiment, the leguminous plant is soybean and the aqueous whey stream generated from the process of refining the soybean is an aqueous soy whey stream.

Aqueous soy whey streams generated in the manufacture of soy protein isolates are generally relatively dilute and are typically discarded as waste. More particularly, the aqueous soy whey stream typically has a total solids content of less than about 10 wt. %, typically less than about 7.5 wt. % and, still more typically, less than about 5 wt. %. For example, in various aspects, the solids content of the aqueous soy whey stream is from about 0.5 to about 10 wt. %, from about 1 wt. % to about 4 wt. %, or from about 1 to about 3 wt. % (e.g. about 2 wt. %). Thus, during commercial soy protein isolate production, a significant volume of waste water that must be treated or disposed is generated.

Soy whey streams typically contain a significant portion of the initial soy protein content of the starting material soybeans. As used herein the term “soy protein” generally refers to any and all of the proteins native to soybeans. Naturally occurring soy proteins are generally globular proteins having a hydrophobic core surrounded by a hydrophilic shell. Numerous soy proteins have been identified including, for example, storage proteins such as glycinin and β-conglycinin. Soy proteins likewise include protease inhibitors, such as the above-noted BBI proteins. Soy proteins also include hemagglutinins such as lectin, lipoxygenases, β-amylase, and lunasin. It is to be noted that the soy plant may be transformed to produce other proteins not normally expressed by soy plants. It is to be understood that reference herein to “soy proteins” likewise contemplates proteins thus produced.

On a dry weight basis, soy proteins constitute at least about 10 wt. %, at least about 15 wt. %, or at least about 20 wt. % of the soy whey stream (dry weight basis). Typically, soy proteins constitute from about 10 to about 40 wt. %, or from about 25 to about 30 wt. % of the soy whey stream (dry weight basis). Soy protein isolates typically contain a significant portion of the storage proteins of the soybean. However, the soy whey stream remaining after isolate precipitation likewise contains one or more soy storage proteins.

In addition to the various soy proteins, the aqueous soy whey stream likewise comprises one or more carbohydrates (i.e. sugars). Generally, sugars constitute at least about 25%, at least about 35%, or at least about 45% by weight of the soy whey stream (dry weight basis). Typically, sugars constitute from about 25% to about 75%, more typically from about 35% to about 65% and, still more typically, from about 40% to about 60% by weight of the soy whey stream (dry weight basis).

The sugars of the soy whey stream generally include one or more monosaccharides, and/or one or more oligosaccharides or polysaccharides. For example, in various aspects, the soy whey stream comprises monosaccharides selected from the group consisting of glucose, fructose, and combinations thereof. Typically, monosaccharides constitute from about 0.5% to about 10 wt. % and, more typically from about 1% to about 5 wt. % of the soy whey stream (dry weight basis). Further in accordance with these and various other aspects, the soy whey stream comprises oligosaccharides selected from the group consisting of sucrose, raffinose, stachyose, and combinations thereof. Typically, oligosaccharides constitute from about 30% to about 60% and, more typically, from about 40% to about 50% by weight of the soy whey stream (dry weight basis).

The aqueous soy whey stream also typically comprises an ash fraction that includes a variety of components including, for example, various minerals, isoflavones, phytic acid, citric acid, saponins, and vitamins. Minerals typically present in the soy whey stream include sodium, potassium, calcium, phosphorus, magnesium, chloride, iron, manganese, zinc, copper, and combinations thereof. Vitamins present in the soy whey stream include, for example, thiamine and riboflavin. Regardless of its precise composition, the ash fraction typically constitutes from about 5% to about 30% and, more typically, from about 10% to about 25% by weight of the soy whey stream (dry weight basis).

The aqueous soy whey stream also typically comprises a fat fraction that generally constitutes from about 0.1% to about 5% by weight of the soy whey stream (dry weight basis). In certain aspects of the invention, the fat content is measured by acid hydrolysis and is about 3% by weight of the soy whey stream (dry weight basis).

In addition to the above components, the aqueous soy whey stream also typically comprises one or more microorganisms including, for example, various bacteria, molds, and yeasts. The proportions of these components typically vary from about 100 to about 1×10⁹ colony forming units (CFU) per milliliter. As detailed elsewhere herein, in various aspects, the aqueous soy whey stream is treated to remove these component(s) prior to protein recovery and/or isolation.

As noted, conventional production of soy protein isolates typically includes disposal of the aqueous soy whey stream remaining following isolation of the soy protein isolate. In accordance with the present disclosure, recovery of one or more proteins and various other components (e.g. sugars and minerals) results in a relatively pure aqueous whey stream. Conventional soy whey streams from which the protein and one or more components have not been removed generally require treatment prior to disposal and/or reuse. In accordance with various aspects of the present disclosure the aqueous whey stream may be disposed of or utilized as process water with minimal, if any, treatment. For example, the aqueous whey stream may be used in one or more filtration (e.g. diafiltration) operations of the present disclosure.

In addition to recovery of BBI proteins from aqueous soy whey streams generated in the manufacture of soy protein isolates, it is to be understood that the processes described herein are likewise suitable for recovery of one or more components of soy molasses streams generated in the manufacture of a soy protein concentrate, as soy molasses streams are an additional type of soy processing stream.

### IV. General Description of Process for Soy Whey Protein Recovery

Generally, the purification of the soy processing stream comprises one or more operations (e.g. membrane separation operations) selected and designed to provide recovery of the desired proteins or other products, or separation of various components of the soy whey stream, or both. Recovery of soy whey proteins (e.g. Bowman-Birk inhibitor (BBI) and Kunitz trypsin inhibitor (KTI) proteins) and one or more other components of the soy whey stream (e.g. various sugars, including oligosaccharides) may utilize a plurality of separation techniques, (e.g. membrane, chromatographic, centrifugation, or filtration). The specific separation technique will depend upon the desired component to be recovered by separating it from other components of the processing stream.

For example, a purified fraction is typically prepared by removal of one or more impurities (e.g. microorganisms or minerals), followed by removal of additional impurities including one or more soy storage proteins (i.e. glycinin and β-conglycinin), followed by removal of one or more soy whey proteins (including, for example, KTI and other non-BBI proteins or peptides), and/or followed by removal of one or more additional impurities including sugars from the soy whey. Recovery of various target components in high purity form is improved by removal of other major components of the whey stream (e.g. storage proteins, minerals, and sugars) that detract from purity by diluents, while likewise improving purity by purifying the protein fraction through removal of components that are antagonists to the proteins and/or have deleterious effects (e.g. endotoxins). Removal of the various components of the soy whey typically comprises concentration of the soy whey prior to and/or during removal of the components of the soy whey. The methods of the present invention also will reduce pollution generated from processing large quantities of aqueous waste.

Removal of storage proteins, sugars, minerals, and impurities yields fractions that are enriched in the individual, targeted proteins and free of impurities that may be antagonists or toxins, or may otherwise have a deleterious effect. For example, typically a soy storage protein-enriched fraction may be recovered, along with a fraction enriched in one or more soy whey proteins. A fraction enriched in one more sugars (e.g. oligosaccharides and/or polysaccharides) is also typically prepared. Thus, the present methods provide a fraction that is suitable as a substrate for recovery of individual, targeted proteins, and also provide other fractions that can be used as substrates for economical recovery of other useful products from aqueous soy whey. For example, removal of sugars and/or minerals from the soy whey stream produces a useful fraction from which the sugars can be further separated, thus yielding additional useful fractions: a concentrated sugar and a mineral fraction (that may include citric acid), and a relatively pure aqueous fraction that may be disposed of with minimal, if any, treatment or recycled as process water. Process water thus produced may be especially useful in practicing the present methods. Thus, a further advantage of the present methods may be reduced process water requirements as compared to conventional isolate preparation processes.

Methods of the present disclosure provide advantages over conventional methods for manufacture of soy protein isolates and concentrates in at least two ways. As noted, conventional methods for manufacturing soy protein materials typically dispose of the soy whey stream (e.g. aqueous soy whey or soy molasses). Thus, the products recovered by the methods of the present disclosure represent an additional product, and a revenue source not currently realized in connection with conventional soy protein isolate and soy protein concentrate manufacture. Furthermore, treatment of the soy whey stream or soy molasses to recover saleable products preferably reduces the costs associated with treatment and disposal of the soy whey stream or soy molasses. For example, as detailed elsewhere herein, various methods of the present invention provide a relatively pure soy processing stream that may be readily utilized in various other processes or disposed of with minimal, if any, treatment, thereby reducing the environmental impact of the process. Certain costs exist in association with the methods of the present disclosure, but the benefits of the additional product(s) isolated and minimization of waste disposal are believed to compensate for any added costs.

The following is a general description of the various steps that make up the overall process. A key to the process is to start with the whey protein pretreatment step, which uniquely changes the soy whey and protein properties. From there, the other steps may be performed using the raw material sources as listed in each step, as will be shown in the discussion of the various embodiments to follow.

It is understood by those skilled in the art of separation technology that there can be residual components in each permeate or retentate stream since separation is never 100%. Further, one skilled in the art realizes that separation technology can vary depending on the starting raw material.

Step 0 (as shown in FIG. 4A)—Whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 1 (as shown in FIG. 4A)—Microbiology reduction can start with the product of the whey protein pretreatment step, including but not limited to pre-treated soy whey. This step involves microfiltration of the pre-treated soy whey. Process variables and alternatives in this step include but are not limited to, centrifugation, dead-end filtration, heat sterilization, ultraviolet sterilization, microfiltration, crossflow membrane filtration, and combinations thereof. Crossflow membrane filtration includes but is not limited to: spiral-wound, plate and frame, hollow fiber, ceramic, dynamic or rotating disk, nanofiber, and combinations thereof. The pH of step 1 can be between about 2.0 and about 12.0, preferably about 5.3. The temperature can be between about 5° C. and about 90° C., preferably about 50° C. Products from step 1 include but are not limited to storage proteins, microorganisms, silicon, and combinations thereof in stream 1a (retentate) and purified pre-treated soy whey in stream 1b (permeate).

Step 2 (as shown in FIG. 4A)—A water and mineral removal can start with the purified pre-treated soy whey from stream 1b or 4a, or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (as shown in FIG. 4A)—the mineral precipitation step can start with purified pre-treated soy whey from stream 2a or pretreated soy whey from streams 0a or 1b. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (as shown in FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (as shown in FIG. 4B)—the protein separation and concentration step can start with purified pre-treated whey from stream 4a or the whey from streams 0a, 1b, or 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (as shown in FIG. 4B)—the protein washing and purification step can start with soy whey protein, BBI, KTI, storage proteins, other proteins or purified pre-treated whey from stream 4a or 5a, or whey from streams 0a, 1b, or 2a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 7 (as shown in FIG. 4C)—a water removal step can start with peptides, soy oligosaccharides, water, minerals, and combinations thereof from stream 5b and/or stream 6b. Soy oligosaccharides include but are not limited to sucrose, raffinose, stachyose, verbascose, monosaccharides, and combinations thereof. It includes a nanofiltration step. Process variables and alternatives in this step include but are not limited to, reverse osmosis, evaporation, nanofiltration, water diafiltration, buffer diafiltration, and combinations thereof. The pH of step 7 can be between about 2.0 and about 12.0, preferably about 7.0. The temperature can be between about 5° C. and about 90° C., preferably about 50° C. Products from stream 7a (retentate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Products from stream 7b (permeate) include but are not limited to, water, minerals, and combinations thereof.

Step 8 (as shown in FIG. 4C)—a mineral removal step can start with peptides, soy oligosaccharides, water, minerals, and combinations thereof from streams 5b, 6b, 7a, and/or 12a. Soy oligosaccharides include but are not limited to sucrose, raffinose, stachyose, verbascose, monosaccharides, and combinations thereof. It includes an electrodialysis membrane step. Process variables and alternatives in this step include but are not limited to, ion exchange columns, chromatography, and combinations thereof. Processing aids that can be used in this mineral removal step include but are not limited to, water, enzymes, and combinations thereof. Enzymes include but are not limited to protease, phytase, and combinations thereof. The pH of step 8 can be between about 2.0 and about 12.0, preferably about 7.0. The temperature can be between about 5° C. and about 90° C., preferably about 40° C. Products from stream 8a (retentate) include but are not limited to, de-mineralized soy oligosaccharides with conductivity between about 10 milli Siemens (mS) and about 0.5 mS, preferably about 2 mS, and combinations thereof. Soy oligosaccharides include but are not limited to sucrose, raffinose, stachyose, verbascose, monosaccharides, and combinations thereof. Products from stream 8b include but are not limited to, minerals, water, and combinations thereof.

Step 9 (as shown in FIG. 4C)—a color removal step can start with de-mineralized soy oligosaccharides from streams 8a, 5b, 6b, and/or 7a). It utilizes an active carbon bed. Process variables and alternatives in this step include but are not limited to, ion exchange. Processing aids that can be used in this color removal step include but are not limited to, active carbon, ion exchange resins, and combinations thereof. The temperature can be between about 5° C. and about 90° C., preferably about 40° C. Products from stream 9a (retentate) include but are not limited to, color compounds. Stream 9b is decolored. Products from stream 9b (permeate) include but are not limited to, soy oligosaccharides, and combinations thereof. Soy oligosaccharides include but are not limited to sucrose, raffinose, stachyose, verbascose, monosaccharides, and combinations thereof.

Step 10 (as shown in FIG. 4C)—a soy oligosaccharide fractionation step can start with soy oligosaccharides, and combinations thereof from streams 9b, 5b, 6b, 7a, and/or 8a. Soy oligosaccharides include but are not limited to sucrose, raffinose, stachyose, verbascose, monosaccharides, and combinations thereof. It includes a chromatography step. Process variables and alternatives in this step include but are not limited to, chromatography, nanofiltration, and combinations thereof. Processing aids that can be used in this soy oligosaccharide fractionation step include but are not limited to acid and base to adjust the pH as one know in the art and related to the resin used. Products from stream 10a (retentate) include but are not limited to, soy oligosaccharides such as sucrose, monosaccharides, and combinations thereof. Products from stream 10b (permeate) include but are not limited to soy oligosaccharides such as, raffinose, stachyose, verbascose, and combinations thereof.

Step 11 (as shown in FIG. 4C)—a water removal step can start with soy oligosaccharides such as, raffinose, stachyose, verbascose, and combinations thereof from streams 9b, 5b, 6b, 7a, 8a, and/or 10a. It includes an evaporation step. Process variables and alternatives in this step include but are not limited to, evaporation, reverse osmosis, nanofiltration, and combinations thereof. Processing aids that can be used in this water removal step include but are not limited to, defoamer, steam, vacuum, and combinations thereof. The temperature can be between about 5° C. and about 90° C., preferably about 60° C. Products from stream 11a (retentate) include but are not limited to, water. Products from stream 11b (permeate) include but are not limited to, soy oligosaccharides, such as, raffinose, stachyose, verbascose, and combinations thereof.

Step 12 (as shown in FIG. 4C)—an additional protein separation from soy oligosaccharides step can start with peptides, soy oligosaccharides, water, minerals, and combinations thereof from stream 7b. Soy oligosaccharides include but are not limited to sucrose, raffinose, stachyose, verbascose, monosaccharides, and combinations thereof. It includes an ultrafiltration step. Process variables and alternatives in this step include but are not limited to, crossflow membrane filtration, ultrafiltration with pore sizes between about 50 kD and about 1 kD, and combinations thereof. Crossflow membrane filtration includes but is not limited to: spiral-wound, plate and frame, hollow fiber, ceramic, dynamic or rotating disk, nanofiber, and combinations thereof. Processing aids that can be used in this protein separation from sugars step include but are not limited to, acids, bases, protease, phytase, and combinations thereof. The pH of step 12 can be between about 2.0 and about 12.0, preferably about 7.0. The temperature can be between about 5° C. and about 90° C., preferably about 75° C. Products from stream 12a (retentate) include but are not limited to, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate. This stream 12a stream can be fed to stream 8. Products from stream 12b (permeate) include but are not limited to, peptides, and other proteins. Other proteins include but are not limited to lunasin, lectins, dehydrins, lipoxygenase, and combinations thereof.

Step 13 (as shown in FIG. 4C)—a water removal step can start with, peptides, and other proteins. Other proteins include but are not limited to lunasin, lectins, dehydrins, lipoxygenase, and combinations thereof. It includes an evaporation step. Process variables and alternatives in this step include but are not limited to, reverse osmosis, nanofiltration, spray drying and combinations thereof. Products from stream 13a (retentate) include but are not limited to, water. Products from stream 13b (permeate) include but are not limited to, peptides, other proteins, and combinations thereof. Other proteins include but are not limited to lunasin, lectins, dehydrins, lipoxygenase, and combinations thereof.

Step 14 (as shown in FIG. 4B)—a protein fractionation step may be done by starting with soy whey protein, BBI, KTI, storage proteins, other proteins, and combinations thereof from streams 6a and/or 5a. Other proteins include but are not limited to lunasin, lectins, dehydrins, lipoxygenase, and combinations thereof. It includes an ultrafiltration (with pore sizes from 100kD to 10kD) step. Process variables and alternatives in this step include but are not limited to, crossflow membrane filtration, ultrafiltration, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 14 can be between about 2.0 and about 12.0, preferably about 7.0. The temperature can be between about 5° C. and about 90° C., preferably about 75° C. Products from stream 14a (retentate) include but are not limited to, storage proteins. Products from stream 14b (permeate) include but are not limited to, soy whey protein, BBI, KTI and, other proteins. Other proteins include but are not limited to lunasin, lectins, dehydrins, lipoxygenase, and combinations thereof.

Step 15 (as shown in FIG. 4B)—a water removal step can start with soy whey protein, BBI, KTI and, other proteins from streams 6a, 5a, and/or 14b. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (as shown in FIG. 4B)—a heat treatment and flash cooling step can start with soy whey protein, BBI, KTI and, other proteins from streams 6a, 5a, 14b, and/or 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Step 17 (as shown in FIG. 4B)—a drying step can start with soy whey protein, BBI, KTI and, other proteins from streams 6a, 5a, 14b, 15b, and/or 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

The soy whey protein products of the current application include raw whey, a soy whey protein precursor after the ultrafiltration step of Step 17, a dry soy whey protein that can be dried by any means known in the art, and combinations thereof. All of these products can be used as is as soy whey protein or can be further processed to purify specific components of interest, such as, but not limited to BBI, KTI, and combinations thereof.

### IV. Preferred Embodiments of the Process for the Recovery of Soy Whey Protein

Embodiment 1 starts with Step 0 (See FIG. 4A) as follows: Whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Next, Step 5 (See FIG. 4B) is done. Thus, the protein separation and concentration step in this embodiment starts with the whey from stream 0a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 2—starts with Step 0 (See FIG. 4A) as follows: Whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Next Step 5 (See FIG. 4B) is done. Thus, the protein separation and concentration step in this embodiment starts with the whey from stream 0a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally Step 6 (See FIG. 4B), the protein washing and purification step starts with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 3 starts with Step 0 (See FIG. 4A) which is a whey protein pretreatment that can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with purified pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Finally, Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 4 starts with Step 0 (See FIG. 4A) whey protein pretreatment that can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with purified pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B)—the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 5 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B)—the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 16 (See FIG. 4B) a heat treatment and flash cooling step can start with soy whey protein, BBI, KTI and, other proteins from streams 6a. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B)—a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 6 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B)—a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 7 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Finally, Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 8 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 9 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 10 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 11 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 2 (See FIG. 4A) a water and mineral removal can start with the pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B)—the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 16 (See FIG. 4B) a heat treatment and flash cooling step can start with soy whey protein, BBI, KTI and, other proteins from stream 6a. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B)—a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 12 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 2 (See FIG. 4A) a water and mineral removal can start with the purified pre-treated soy whey from stream 1b or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 13 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with pre-treated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 1b or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Finally, Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Embodiment 14 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with pretreated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 4a. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Finally, Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Embodiment 15 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with pretreated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 1b or pre-treated soy whey from stream 0b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 16 (See FIG. 4B) a heat treatment and flash cooling step can start with soy whey protein, BBI, KTI and, other proteins from stream 6a. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 16 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 3 (See FIG. 4A) the mineral precipitation step can start with pretreated soy whey from stream 0a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A) a water and mineral removal can start with the purified pre-treated soy whey from stream 4a. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, RO, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 17 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 1 (See FIG. 4A) Microbiology reduction can start with the product of the whey protein pretreatment step, including but not limited to pre-treated soy whey. This step involves microfiltration of the pre-treated soy whey. Process variables and alternatives in this step include but are not limited to, centrifugation, dead-end filtration, heat sterilization, ultraviolet sterilization, microfiltration, crossflow membrane filtration, and combinations thereof. Crossflow membrane filtration includes but is not limited to: spiral-wound, plate and frame, hollow fiber, ceramic, dynamic or rotating disk, nanofiber, and combinations thereof. The pH of step 1 can be between about 2.0 and about 12.0, preferably about 5.3. The temperature can be between about 5° C. and about 90° C., preferably about 50° C. Products from step 1 include but are not limited to storage proteins, microorganisms, silicon, and combinations thereof in stream 1a (retentate) and purified pre-treated soy whey in stream 1b (permeate).

Step 3 (See FIG. 4A) the mineral precipitation step can start with pretreated soy whey from stream 1b. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A) the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 2 (See FIG. 4A)—A water and mineral removal can start with the purified pre-treated soy whey from stream 4a. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 5 (See FIG. 4B) the protein separation and concentration step can start with the whey from stream 2a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, reverse osmosis, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

Embodiment 18 starts with Step 0 (See FIG. 4A) the whey protein pretreatment can start with feed streams including but not limited to isolated soy protein (ISP) molasses, ISP whey, soy protein concentrate (SPC) molasses, SPC whey, functional soy protein concentrate (FSPC) whey, and combinations thereof. Processing aids that can be used in the whey protein pretreatment step include but are not limited to, acids, bases, sodium hydroxide, calcium hydroxide, hydrochloric acid, water, steam, and combinations thereof. The pH of step 0 can be between about 3.0 and about 6.0, preferably 4.5. The temperature can be between about 70° C. and about 95° C., preferably about 85° C. Temperature hold times can vary between about 0 minutes to about 20 minutes, preferably about 10 minutes. Products from the whey protein pretreatment include but are not limited to soluble components in the aqueous phase of the whey stream (pre-treated soy whey) (molecular weight of equal to or less than about 50 kDa) in stream 0a (retentate) and insoluble large molecular weight proteins (between about 300 kDa and between about 50 kDa) in stream 0b (permeate), such as pre-treated soy whey, storage proteins, and combinations thereof.

Step 1 (See FIG. 4A) Microbiology reduction can start with the product of the whey protein pretreatment step, including but not limited to pre-treated soy whey. This step involves microfiltration of the pre-treated soy whey. Process variables and alternatives in this step include but are not limited to, centrifugation, dead-end filtration, heat sterilization, ultraviolet sterilization, microfiltration, crossflow membrane filtration, and combinations thereof. Crossflow membrane filtration includes but is not limited to: spiral-wound, plate and frame, hollow fiber, ceramic, dynamic or rotating disk, nanofiber, and combinations thereof. The pH of step 1 can be between about 2.0 and about 12.0, preferably about 5.3. The temperature can be between about 5° C. and about 90° C., preferably about 50° C. Products from step 1 include but are not limited to storage proteins, microorganisms, silicon, and combinations thereof in stream 1a (retentate) and purified pre-treated soy whey in stream 1b (permeate).

Step 2 (See FIG. 4A) a water and mineral removal can start with the purified pre-treated soy whey from stream 1b. It includes a nanofiltration step for water removal and partial mineral removal. Process variables and alternatives in this step include but are not limited to, crossflow membrane filtration, reverse osmosis, evaporation, nanofiltration, and combinations thereof. Crossflow membrane filtration includes but is not limited to: spiral-wound, plate and frame, hollow fiber, ceramic, dynamic or rotating disk, nanofiber, and combinations thereof. The pH of step 2 can be between about 2.0 and about 12.0, preferably about 5.3. The temperature can be between about 5° C. and about 90° C., preferably about 50° C. Products from this water removal step include but are not limited to purified pre-treated soy whey in stream 2a (retentate) and water, some minerals, monovalent cations and combinations thereof in stream 2b (permeate).

Step 3 (See FIG. 4A) the mineral precipitation step can start with purified pre-treated soy whey from stream 2a. It includes a precipitation step by pH and/or temperature change. Process variables and alternatives in this step include but are not limited to, an agitated or recirculating reaction tank. Processing aids that can be used in the mineral precipitation step include but are not limited to, acids, bases, calcium hydroxide, sodium hydroxide, hydrochloric acid, sodium chloride, phytase, and combinations thereof. The pH of step 3 can be between about 2.0 and about 12.0, preferably about 8.0. The temperature can be between about 5° C. and about 90° C., preferably about 50° C. The pH hold times can vary between about 0 minutes to about 60 minutes, preferably about 10 minutes. The product of stream 3 is a suspension of purified pre-treated soy whey and precipitated minerals.

Step 4 (See FIG. 4A)—the mineral removal step can start with the suspension of purified pre-treated whey and precipitated minerals from stream 3. It includes a centrifugation step. Process variables and alternatives in this step include but are not limited to, centrifugation, filtration, dead-end filtration, crossflow membrane filtration and combinations thereof. Crossflow membrane filtration includes but is not limited to: spiral-wound, plate and frame, hollow fiber, ceramic, dynamic or rotating disk, nanofiber, and combinations thereof. Products from the mineral removal step include but are not limited to a de-mineralized pre-treated whey in stream 4a (retentate) and insoluble minerals with some protein mineral complexes in stream 4b (permeate).

Step 5 (See FIG. 4B) the protein separation and concentration step can start with purified pre-treated whey from stream 4a. It includes an ultrafiltration step. Process variables and alternatives in this step include but are not limited to, crossflow membrane filtration, ultrafiltration, and combinations thereof. Crossflow membrane filtration includes but is not limited to: spiral-wound, plate and frame, hollow fiber, ceramic, dynamic or rotating disk, nanofiber, and combinations thereof. The pH of step 5 can be between about 2.0 and about 12.0, preferably about 8.0. The temperature can be between about 5° C. and about 90° C., preferably about 75° C. Products from stream 5a (retentate) include but are not limited to, soy whey protein, BBI, KTI, storage proteins, other proteins and combinations thereof. Other proteins include but are not limited to lunasin, lectins, dehydrins, lipoxygenase, and combinations thereof. Products from stream 5b (permeate) include but are not limited to, peptides, soy oligosaccharides, minerals and combinations thereof. Soy oligosaccharides include but are not limited to sucrose, raffinose, stachyose, verbascose, monosaccharides, and combinations thereof. Minerals include but are not limited to calcium citrate.

Step 6 (See FIG. 4B) the protein washing and purification step can start with soy whey protein, BBI, KTI, storage proteins, other proteins or purified pre-treated whey from stream 5a. It includes a diafiltration step. Process variables and alternatives in this step include but are not limited to, reslurrying, crossflow membrane filtration, ultrafiltration, water diafiltration, buffer diafiltration, and combinations thereof. Crossflow membrane filtration includes but is not limited to: spiral-wound, plate and frame, hollow fiber, ceramic, dynamic or rotating disk, nanofiber, and combinations thereof. Processing aids that can be used in the protein washing and purification step include but are not limited to, water, steam, and combinations thereof. The pH of step 6 can be between about 2.0 and about 12.0, preferably about 7.0. The temperature can be between about 5° C. and about 90° C., preferably about 75° C. Products from stream 6a (retentate) include but are not limited to, soy whey protein, BBI, KTI, storage proteins, other proteins, and combinations thereof. Other proteins include but are not limited to lunasin, lectins, dehydrins, lipoxygenase, and combinations thereof. Products from stream 6b (permeate) include but are not limited to, peptides, soy oligosaccharides, water, minerals, and combinations thereof. Soy oligosaccharides include but are not limited to sucrose, raffinose, stachyose, verbascose, monosaccharides, and combinations thereof. Minerals include but are not limited to calcium citrate.

Step 15 (See FIG. 4B) a water removal step can start with soy whey protein, BBI, KTI and, other proteins from stream 6a. Other proteins include but are not limited to lunasin, lectins, dehydrins, lipoxygenase, and combinations thereof. It includes an evaporation step. Process variables and alternatives in this step include but are not limited to, evaporation, nanofiltration, reverse osmosis, and combinations thereof. Products from stream 15a (retentate) include but are not limited to, water. Stream 15b (permeate) products include but are not limited to soy whey protein, BBI, KTI and, other proteins. Other proteins include but are not limited to lunasin, lectins, dehydrins, lipoxygenase, and combinations thereof.

Step 16 (See FIG. 4B) a heat treatment and flash cooling step can start with soy whey protein, BBI, KTI and, other proteins from stream 15b. Other proteins include but are not limited to lunasin, lectins, dehydrins, lipoxygenase, and combinations thereof. It includes an ultra high temperature step. Process variables and alternatives in this step include but are not limited to, heat sterilization, evaporation, and combinations thereof. Processing aids that can be used in this heat treatment and flash cooling step include but are not limited to, water, steam, and combinations thereof. The temperature can be between about 129° C. and about 160° C., preferably about 152° C. Temperature hold time can be between about 8 seconds and about 15 seconds, preferably about 9 seconds. Products from stream 16 include but are not limited to, soy whey protein.

Finally, Step 17 (See FIG. 4B) a drying step can start with soy whey protein, BBI, KTI and, other proteins from stream 16. It includes a drying step. The liquid feed temperature can be between about 50° C. and about 95° C., preferably about 82° C. The inlet temperature can be between about 175° C. and about 370° C., preferably about 290° C. The exhaust temperature can be between about 65° C. and about 98° C., preferably about 88° C. Products from stream 17a (retentate) include but are not limited to, water. Products from stream 17b (permeate) include but are not limited to, soy whey protein which includes, BBI, KTI and, other proteins. Other proteins include but are not limited to lunasin, lectins, dehydrins, lipoxygenase, and combinations thereof.

### V. Food Products Comprising a Foaming Agent

The present disclosure further relates to food products that contain a foaming agent comprising an amount of soy whey protein having a SSI of at least about 80% across a pH range of from 2 to 10 and a temperature of 25° C. The foaming agent disclosed herein is suitable for use in a variety of food products, but is especially suitable for use in food products requiring aeration, such as, for example, whipped toppings, baked dessert products (such as meringues, cakes, nougats, etc.), beverages (including alcoholic beverages and coffee beverages), confections, frozen confections and frozen desserts, and the like. One of skill in the art will appreciate that the amount of foaming agent used can and will vary depending upon the desired food product.

In one embodiment, the food product comprising the foaming agent may be a dessert product, such as pudding, whipped topping, meringue, confection (such as nougat), cake, frozen confection, or frozen dessert such as ice cream, sherbert, and sorbet.

In another embodiment, the food product comprising the foaming agent may be a sauce product.

In another embodiment, the food product comprising the foaming agent may be a soup product.

In another embodiment, the food product comprising the foaming agent may be a beverage product, including milkshakes, smoothies, alcoholic beverages (such as beer or sparkling wine), and foam coffee products (such as cappuccinos).

Typically, the amount of foaming agent present in the food product can and will vary depending on the desired food product and the amount of foam needed to make the food product. By way of example, the food product may contain between about 0.02% and about 10% (by weight) of a foaming agent. Specifically, the food product may contain about 10%, 9%, 8%, 7%, 6%, 5%, 4%, 3%, 2.5%, 2%, 1.5%, 1%, 0.50%, 0.25%, 0.1%, 0.05% or 0.02% (by weight) of a foaming agent. In one embodiment, the amount of foaming agent present in the food product may range from about 0.02% to about 3% by weight. Additionally, the amount of foaming agent present in the food product may comprise between about 0.02% to about 2% by weight.

The foaming agent may be added at the initial hydration step or to the pre-mix or at a subsequent processing step in the preparation of the food product. In one embodiment, the foaming agent is added in water as part of the initial hydration of the protein followed by the addition of other ingredients. In an alternative embodiment, the foaming agent is added to the dry ingredients in a dry form as part of the dry blend pre-mix before adding to the liquid ingredients.

a. Additional Ingredients

In addition to the foaming agent containing an amount of soy whey protein, a variety of other ingredients may be added to the food product at the pre-blend or at a subsequent processing step without departing from the scope of the invention. For example, carbohydrates, dietary fiber, stabilizers, water, antioxidants, antimicrobial agents, fat sources, pH-adjusting agents, preservatives, dairy products, flavoring agents, sweetening agents, coloring agents, other nutrients, and combinations thereof may be included in the pre-blend for the food product.

6. Additional Foaming Agent

The food product may optionally include at least one additional foaming agent such as, mono- and diglycerides of fatty acids, esters of monoglycerides of fatty acids, propylene glycol monoesters, lecithin, hydroxylated lecithin, dioctyl sodium sulphosuccinate, sodium stearoyl-2-lactylate (SSL), calcium stearoyl lactylate (CSL), sorbitan monolaurate (Polysorbate 20 or Tween20), sorbitan monopalmitate (Polysorbate 40 or Tween40), sorbitan monostearate (Polysorbate 60 or Tween60), sorbitan monooleate (Polysorbate or Tween80), sorbitan tristearate, stearyl citrate, and polyglycerol polyricinoleate (PGPR), albumin, gluten, casein, caseinate, dairy whey protein, and combinations thereof. As will be appreciated by one of skill in the art, the amount of additional foaming agent, if any, added to the food product can and will depend upon the type of food product desired.

2. Protein-containing material

In addition to the soy whey protein present in the foaming agent, proteins other than soy whey protein may optionally be present in the food product. While ingredients comprising proteins derived from plants are typically used, it is also envisioned that proteins derived from other sources, such as animal sources, may be utilized without departing from the scope of the invention. For example, a dairy protein selected from the group consisting of casein, caseinates, whey protein, and mixtures thereof, may be utilized. By way of further example, an egg protein selected from the group consisting of ovalbumin, ovoglobulin, ovomucin, ovomucoid, ovotransferrin, ovovitella, ovovitellin, albumen, globulin, vitellin, and combinations thereof may be used.

3. Carbohydrate source

The food product may further include at least one carbohydrate source. Generally, the carbohydrate source is starch (pre-gelatinized starch or a modified food starch), sugar, or flour (for example wheat, rice, corn, peanut, or konjac). Suitable starches are known in the art and may include starches derived from vegetables (including legumes) or grains. Non-limiting examples of suitable carbohydrates may include fiber, such as oligofructose and soy fiber, guar gum, locust bean gum, starch derived from corn, potato, rice, wheat, arrowroot, guar gum, locust bean, tapioca, arracacha, buckwheat, banana, barley, cassava, konjac, kudzu, oca, sago, sorghum, sweet potato, taro, yams, and mixtures thereof. Edible legumes, such as soy, favas, lentils and peas are also rich in suitable carbohydrates. Non-limiting examples of suitable sugars include sucrose, dextrose, lactose, fructose, galactose, maltose, maltodextrin, mannose, glucose, and combinations thereof.

Regardless of the specific carbohydrate source used, the percentage of starch and or type of carbohydrate (e.g., maltodextrin low dextrose equivalent (DE) vs. high DE corn syrup solids) utilized in the food product typically determines, in part, its texture when it is expanded. As such, the amount of carbohydrates present in the food product can and will vary depending on the desired texture of the resultant food product. For example, the amount of carbohydrates present in the food product may range from about 1% to about 30% by weight. In another embodiment, the amount of carbohydrates present in the food product may range from about 3% to about 20% by weight. In an additional embodiment, the amount of carbohydrates that may be present in the food product may range from about 5% to about 10% by weight.

4. Fat Source

The food product may contain at least one fat source which may be liquid or solid at room temperature. Non-limiting examples of suitable fats include edible oils that are liquid at room temperature, such as for rapeseed oil, soybean oil, sunflower oil, canola oil, corn oil, olive oil, peanut oil, and cottonseed oil, vegetable oil, and any other fat source that is liquid at room temperature (e.g., cream), as well as fats that are solid at room temperature, for example shortening, margarine, butter, lard, palm oil, coconut oil, etc. In one embodiment, the food product may contain vegetable oil. In another embodiment, the food product may contain butter. The amount of fat present in the food product will depend, in part, on the type of fat used and desired food product. Generally, the food product may comprise between about 0% and about 50% by weight of a fat source. In one embodiment, the food product may comprise between about 0% and about 25% by weight of a fat source.

5. Stabilizer

The food product comprising the foaming agent may optionally contain a stabilizer to inhibit the separation of the food product into air and water phases. Because the soy whey proteins prepared in accordance with the present invention have been found to further exhibit stabilizing properties in addition to foaming properties, additional stabilizers may not be needed. However, non-limiting examples of suitable stabilizers in the art that could be used in addition to soy whey protein include pectin, agar agar, locust bean gum, xanthan gum, guar gum, alginic acid, carrageenan, gelatin, potassium bitartrate (i.e., cream of tartar), and combinations thereof. The stabilizer may be present in the food product at a level from about 0.005% to about 10% and preferably from about 0.025% to about 5%. As will be appreciated by one of skill in the art, the amount of stabilizer, if any, added to the food product can and will depend upon the type of food product desired.

6. Antioxidant

Antioxidant additives include ascorbic acid, Butylated hydroxyanisole (BHA), Butylated hydroxytoluene (BHT), Tert-butylhydroquinone (TBHQ), vitamins A, C, and E and derivatives, and various plant extracts such as rosemarinic acid and those containing carotenoids, tocopherols or flavonoids having antioxidant properties, may be included to increase the shelf-life or nutritionally enhance the food product. The antioxidants may have a presence at levels from about 0.001′)/0 to about 1% by weight of the composition.

7. pH-Adjusting Agent

In some embodiments, it may be desirable to lower or raise the pH of the food product depending on the type of food product desired. Thus, the combined food ingredients may be contacted with a pH-adjusting agent. In one embodiment, the pH of the combined ingredients may range from about 2.5 to about 8.0. In another embodiment, the pH of the combined ingredients may be higher than about 7.2. In yet another embodiment, the pH of the combined ingredients may be lower than about 4.0. Several pH-adjusting agents are suitable for use in the invention. The pH-adjusting agent may be organic or inorganic. In exemplary embodiments, the pH-adjusting agent is a food grade edible acid. Non-limiting acids suitable for use in the invention include acetic, lactic, hydrochloric, phosphoric, citric, tartaric, malic, glucono, deltalactone, gluconic, and combinations thereof. In an exemplary embodiment, the pH-adjusting agent is citric acid. In an alternative embodiment, the pH-adjusting agent may be a pH-raising agent, such as but not limited to disodium diphosphate, sodium hydroxide, and potassium hydroxide. As will be appreciated by a skilled artisan, the amount of pH-adjusting agent placed in contact with the combined ingredients can and will vary depending on several parameters, including, the agent selected and the desired pH.

8. Flavorings

The food product may optionally include a variety of flavorings, spices, or other ingredients to naturally enhance the taste of the final food product. As will be appreciated by a skilled artisan, the selection of ingredients added to the food product can and will depend upon the type of food product desired.

In one embodiment, the food product may further comprise a flavoring agent. The flavoring agent may include any suitable edible flavoring agent known in the art including, but not limited to, salt, any flower flavor, any spice flavor, vanilla, any fruit flavor, caramel, nut flavor, beef, poultry (e.g. chicken or turkey), pork or seafood flavors, dairy flavors such as butter and cheese, any vegetable flavor, and combinations thereof.

The flavoring may also be sweet. Sugar, sweet dairy whey, soy molasses, corn syrup solids, honey, glucose, sucrose, fructose, maltodextrin, aspartame, neotame, sucralose, corn syrup (liquid or solids), acesulfame potassium, stevia, monk fruit extract, maple syrup, etc. may be used for sweet flavors. Additionally, other sweet flavors may be used (e.g., chocolate, chocolate mint, caramel, toffee, butterscotch, mint, coconut, and peppermint flavorings). Sugar alcohols may also be used as sweeteners.

A wide variety of fruit, citrus flavors, or citrus oils may also be used in the food product. Non-limiting examples of fruit or citrus flavors include strawberry, banana, raspberry, pineapple, coconut, cherry, orange, and lemon flavors.

Herbs, herb oils, or herb extracts that may be added include basil, celery leaves, chervil, chives, cilantro, parsley, oregano, rosemary, tarragon, and thyme.

9. Dairy Product

The food product may optionally include an ingredient that is a dairy product. Suitable non-limiting examples of dairy products that may additionally be added to the food product are skim milk, reduced fat milk, 2% milk, whole milk, cream, ice cream, evaporated milk, yogurt, buttermilk, dry milk powder, non-fat dry milk powder, milk proteins, acid casein, caseinate (e.g., sodium caseinate, calcium caseinate, etc.), whey protein concentrate, whey protein isolate, and combinations thereof.

10. Coloring Agent

In an additional embodiment, the food product may further comprise a coloring agent. The coloring agent may be any suitable food coloring, additive, dye or lake known to those skilled in the art. Suitable food colorants may include, but are not limited to, for example, Food, Drug and Cosmetic (FD&C) Blue No. 1, FD&C Blue No. 2, FD&C Green No. 3, FD&C Red No. 3, FD&C Red No. 40, FD&C Yellow No. 5, FD&C Yellow No. 6, Orange B,

Citrus Red No. 2 and combinations thereof. Other coloring agents may include annatto extract, β-apo-8′-carotenal, β-carotene, beet powder, astaxanthin, canthaxanthin, caramel color, carrot oil, cochineal extract, cottonseed flour, ferrous gluconate, fruit juice, grape color extract, paprika, riboflavin, saffron, titanium dioxide, turmeric, vegetable juice and combinations thereof. These coloring agents may be combined or mixed as is common to those skilled in the art to produce a final coloring agent.

11. Nutrients

In a further embodiment, the food product may further comprise a nutrient such as a vitamin, a mineral, an antioxidant, an omega-3 fatty acid, or an herb. Suitable vitamins include Vitamins A, C and E, which are also antioxidants, and Vitamins B and D. Examples of minerals that may be added include the salts of aluminum, ammonium, calcium, magnesium, potassium and combinations thereof. Suitable omega-3 fatty acids include docosahexaenoic acid (DHA), stearidonic acid (SDA), hexadecatrienoic acid (HTA), α-linolenic acid (ALA), eicosatrienoic acid (ETE), eicosatetraenoic acid (ETA), eicosapentaenoic acid (EPA), heneicosapentaenoic acid (HPA), docosapentaenoic acid (DPA), tetracosapentaenoic acid, arachidonic acid (ARA), tetracosahexanenoic acid, and combinations thereof.

VI. Method of Making Food Products

As referenced herein, the food products comprising a foaming agent containing an amount of soy whey protein may undergo typical processing known in the industry to produce the desired food product. Generally speaking, any method of processing known in the industry can be used to produce the desired food products. These methods can include but are not limited to sparging, shaking, whipping, and pouring.

For example, in one embodiment, the food products that include the foaming agent may undergo processing involving ingredient blending and a heat treatment step. In another embodiment, the compositions may additionally undergo a sterile filtration step. In another embodiment, the compositions may additionally undergo pasteurization either prior or subsequent to any initial heat treatment. In a further embodiment, the compositions may additionally undergo homogenization prior to, subsequent to or in lieu of pasteurization. In yet another embodiment, the compositions may additionally be cooled in accordance with typical industry standards following the heat treatment, pasteurization and/or homogenization, prior to forming a food product. The cooling of the food product may include refrigeration, freezing, or a combination of both.

### DEFINITIONS

To facilitate understanding of the invention, several terms are defined below.

The term “acid soluble” as used herein refers to a substance having a solubility of at least about 80% with a concentration of 10 grams per liter (g/L) in an aqueous medium having a pH of from about 2 to about 7.

The terms “soy protein isolate” or “isolated soy protein,” as used herein, refer to a soy material having a protein content of at least about 90% soy protein on a moisture free basis.

The term “soluble solids index” or “SSI” as used herein refers to the solubility of a soy protein material in an aqueous solution as measured according to the following formula: SSI (%)=(Soluble Solids/Total) Solids)×100. Soluble Solids and Total Solids are determined as provided in Example 13.

The term “other proteins” as used herein referred to throughout the application are defined as including but not limited to: lunasin, lectins, dehydrins, lipoxygenase, and combinations thereof.

The term “soy whey protein” as used herein is defined as including protein soluble at those pHs where soy storage proteins are typically insoluble, including but not limited to BBI, KTI, lunasin, lipoxygenase, dehydrins, lectins, and combinations thereof. Soy whey protein may further include storage proteins.

The term “proteins other than soy whey protein” is defined as any animal or vegetable protein other than soy protein.

The term “processing stream” as used herein refers to the secondary or incidental product derived from the process of refining a whole legume or oilseed, including an aqueous or solvent stream, which includes, for example, an aqueous soy extract stream, an aqueous soymilk extract stream, an aqueous soy whey stream, an aqueous soy molasses stream, an aqueous soy protein concentrate soy molasses stream, an aqueous soy permeate stream, and an aqueous tofu whey stream, and additionally includes soy whey protein, for example, in both liquid and dry powder form, that can be recovered as an intermediate product in accordance with the methods disclosed herein.

The term “food products” as used herein broadly refers to a mixture of a combination of safe and suitable ingredients including, but not limited to, a foaming agent containing an amount of soy whey protein, water, fat sources, proteins other than soy whey protein, and carbohydrates. Other ingredients such as additional foaming agents, dairy products, sweeteners, pH-adjusting agents, antioxidants, nutrients, coloring agents, and flavorings and may also be included.

When introducing elements of the present invention or the preferred embodiments(s) thereof, the articles “a,” “an,” “the” and “said” are intended to mean that there are one or more of the elements. The terms “comprising,” “including” and “having” are intended to be inclusive and mean that there may be additional elements other than the listed elements.

The term “invention” or “present invention” as used herein is a non-limiting term and is not intended to refer to any single embodiment of the particular invention but encompasses all possible embodiments as described in the specification and the claims.

As used herein, the term “about” modifying the quantity of an ingredient of the invention employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

As various changes could be made in the above compounds, products and methods without departing from the scope of the invention, it is intended that all matter contained in the above description and in the examples given below, shall be interpreted as illustrative and not in a limiting sense.

### EXAMPLES

### Example 1

### Recovery and Fractionation of Soy Whey Protein from Aqueous Soy Whey Using Novel Membrane Process

145 liters of aqueous raw soy whey (not pre-treated) with a total solids content of 3.7% and dry basis protein content of 19.8% was microfiltered using two different membranes in an OPTISEP® 7000 module, manufactured by SmartFlow Technologies. The first membrane, BTS-25, was a polysulfone construction with 0.5 um pore size manufactured by Pall. Aqueous soy whey was concentrated to a 1.6× factor, at an average flux of 30 liters/meter2/hr (LMH). The concentrated aqueous soy whey was then passed through a modified polysulfone microfiltration membrane, MPS 0.45, manufactured by Pall. The aqueous soy whey was concentrated from 1.6× to 11× at an average flux of 28 LMH.

Permeate from the microfiltration process, 132 liters total, was then introduced into an OPTISEP® 7000 module with ultrafiltration membranes, RC100, which are 100 kDa regenerated cellulose membranes manufactured by Microdyn-Nadir. The microfiltered aqueous soy whey was concentrated to about 20× using a 20 L tank setup at an average flux of 30 LMH before being transferred to a 5 L tank setup in order to minimize the hold-up volume of the system. In the smaller tank, the aqueous soy whey was concentrated from 20× to 66× at an average flux rate of 9 LMH, reaching a final retentate volume of 2 liters. The final retentate was 24.0% total solids, and 83.0% dry basis protein content.

128 liters of sugar and mineral enriched RC100 permeate was then introduced into an OPTISEP® 7000 module with polysulfone thin film nanofiltration membranes with a 35% NaCl rejection rate, NF20, manufactured by Sepro. The feed was concentrated 18× at an average flux rate of 4.7 LMH. The retentate from this process step, 9 liters, was enriched in the various sugar species. The permeate stream from the NF20 separation process, 121 liters, contained the minerals and water.

The permeate of the NF20 process was then introduced into an OPTISEP® 3000 module with thin film reverse osmosis membranes with a 98.2% NaCl rejection rate, SG, manufactured by GE. The feed was concentrated 12× at an average flux rate of 8 LMH. The permeate of the SG membrane, 9.2 liters, consisted primarily of water, suitable for re-use in a process with minimal further treatment. The retentate of the SG process, 0.8 liters, consisted predominantly of a concentrated mineral fraction.

### Example 2

### Recovery and Fractionation of Soy Whey Protein from Soy Molasses Using Novel Membrane Process

61.7 liters of soy molasses with a total solids content of 62.7% and dry basis protein content of 18.5% was diluted with 61.7 liters of water prior to microfiltration. The diluted soy molasses was then microfiltered using an OPTISEP® 7000 module, manufactured by SmartFlow Technologies. The diluted soy molasses passed through a modified polysulfone microfiltration membrane, MPS 0.45, manufactured by Pall. The diluted soy molasses was concentrated to a 1.3× factor, at an average flux of 6 liters/meter2/hr (LMH).

Permeate from the microfiltration process, 25 liters total, was then introduced into an OPTISEP® 7000 module with ultrafiltration membranes, RC100, which are 100 kDa regenerated cellulose membranes manufactured by Microdyn-Nadir. The microfiltered diluted soy molasses was diafiltered with 2 volumes of water prior to being concentrated to 7.6× at an average flux of 20 LMH, reaching a final retentate volume of 2 liters. The final retentate was 17.5% total solids, and 22.0% dry basis protein content.

72 liters of sugar and mineral enriched RC100 permeate was then introduced into an OPTISEP® 7000 module with polysulfone thin film nanofiltration membranes with a 35% NaCl rejection rate, NF20, manufactured by Sepro. The feed was concentrated 3× at an average flux rate of 4.0 LMH. The retentate from this process step, 23 liters, was enriched in the various sugar species. The permeate stream from the NF20 separation process, 48 liters, contained the minerals and water.

A portion of the permeate of the NF20 process, 10 liters, was then introduced into an OPTISEP® 3000 module with thin film reverse osmosis membranes with a 98.2% NaCl rejection rate, SG, manufactured by GE. The feed was concentrated 6.7× at an average flux rate of 7.9 LMH. The permeate of the SG membrane, 8.5 liters, consisted primarily of water, suitable for re-use in a process with minimal further treatment. The retentate of the SG process, 1.5 liters, consisted predominantly of a concentrated mineral fraction.

### Example 3

### Capture of Bulk Soy Whey Protein from Defatted Soy Flour Extract

Defatted soy flour (DSF) was extracted by adding a 15:1 ratio of water to DSF at a pH of 7.8 and stirring for 20 minutes prior to filtration. The extract was microfiltered using an OPTISEP® 800 module, manufactured by SmartFlow Technologies. The microfiltration membrane, MMM-0.8, was a polysulfone and polyvinylpropylene construction with 0.8 um pore size manufactured by Pall. Aqueous soy extract was concentrated to a 2.0× factor, at an average flux of 29 liters/meter2/hr (LMH). Permeate from the microfiltration process was then introduced into an OPTISEP® 800 module with ultrafiltration membranes, RC100, which are 100 kDa regenerated cellulose membranes manufactured by Microdyn-Nadir. The microfiltered aqueous soy extract was concentrated to about 6.3× at an average flux rate of 50 LMH. The final retentate measured 84.7% dry basis protein content.

### Example 4

### Capture of Bulk Soy Whey Protein Using Continuous Separation Technology CSEP (Simulated Moving Bed Chromatography)

CSEP experiments were performed by passing feed material (soy whey) through a column (ID 1.55 cm, length 9.5 cm, volume 18 mL) packed with SP GibcoCel resin. The column was connected to a positive displacement pump and samples of flow through and eluates were collected at the outlet of the column. Different experimental conditions were used to determine the effect of feed concentration, feed flow rate and elution flow rate on the binding capacity of the resin.

Feed Concentration

Soy whey was prepared from the defatted soy flake. Briefly, one part of defatted flake was mixed with 15 parts of water at 32° C. The pH of the solution was adjusted to 7.0 using 2 M NaOH and proteins were extracted into the aqueous phase by stirring the solution for 15 min. The protein extract was separated from the insoluble material by centrifugation at 3000×g for 10 min. The pH of the collected supernatant was adjusted to 4.5 using 1 M HCl and the solution was stirred for 15 min followed by heating to a temperature of 57° C. This treatment resulted in precipitation of the storage proteins while the whey proteins remained soluble. The precipitated proteins were separated from the whey by centrifugation at 3000×g for 10 min.

In some cases, the soy whey was concentrated using a Lab-Scale Amicon DC-10LA ultrafiltration unit and Amicon 3K membrane. Prior to ultrafiltration, pH of soy whey was adjusted to 5.5 with 2 M NaOH to avoid membrane fouling at acidic conditions. 10 L of whey was processed with the flux at −100 mL/min. Once the concentration factor of 5 in the retentate was reached, both retentate and permeate streams were collected. Soy whey concentrates 2.5×, 3×, and 4× were prepared by mixing a known amount of permeate and 5× whey concentrate. The pH of all soy concentrates was readjusted if necessary to 4.5.

Feed Flow Rate

During dynamic adsorption, as fluid flows through the resin bed, the proteins are adsorbed by the resin and reach equilibrium with the liquid phase. As the whey is loaded onto the column, the bound protein band extends down the column and reaches equilibrium with the liquid phase. When the resin is saturated with adsorbed proteins, the concentration of the proteins in the liquid phase exiting the column will be similar to the protein concentration in the feed. The curve describing the change in the flow through concentration compared to the feed concentration with the passage of fluid is the breakthrough curve. The concentration of protein in the solid phase increases as the breakthrough curve is developed, and the adsorption wave moves through the bed. As more fluid is passed through the bed, the flow through concentration increases asymptotically to the incoming fluid stream and at the same time a similar phenomena is achieved with the solid phase.

The flow through protein concentration data at three different linear velocity rates were plotted against the column volumes of soy whey loaded (see FIG. 5). These data indicated that increasing the linear flow rate of loading by a factor of 3 resulted in about 10% increase in the unabsorbed proteins in the flow through after loading 6 column volumes of soy whey. Therefore the linear flow rate does not significantly impact the adsorption characteristics of the soy whey proteins with the SP Gibco resin. The equilibrium adsorption data (see FIG. 6) showed that the soy whey protein adsorbed on the resin (calculated using mass balance of protein feed to the system and the protein concentration in the flow through, in equilibrium with the protein in the liquid stream, and plotted against the column volumes passed through the resin bed) varied little with flow rate of the feed at the fluxes tested.

The profile of the breakthrough curve, where soy whey and soy whey concentrated by a factor of 3 and 5 was applied to an SP Gibco resin bed at 15 mL/min (8.5 cm/min linear flow rate), was similar with all three concentrations (see FIG. 7). This result indicated that as the feed protein concentration was increased the resin reached equilibrium with the protein concentration in the liquid stream by striving to reach maximum capacity. This increased adsorption is depicted in FIG. 8 where the protein concentration in the solid phase in equilibrium with the liquid phase has been plotted against the column volumes of soy whey passed through the bed. These data show that the protein adsorbed by the resin significantly increased with soy whey concentration factor, and hence the protein concentration in the soy whey (see FIG. 8). FIG. 9 shows the equilibrium characteristics of the resin and the flow through. This chart shows that as the number of column volumes were passed through the bed, the adsorption of proteins in the resin phase increased asymptotically but the protein content in the flow through also increased. Adsorption capacity can be increased by using concentrated whey and loading at high column volumes but this resulted in a relatively high protein content in the flow through. However, the high protein content in the flow through was minimized by counter current operation using a 2-stage adsorption strategy.

Based on the dynamic adsorption data (see FIG. 9), loading whey concentrated by factor >5 to achieve a protein concentration of >11 mg/mL and loading about 3.5 column volumes resulted in about 35 mg protein adsorbed per mL of resin, and the equilibrium protein concentration in the flow through was about 6.8 mg/mL. Presenting this primary flow through to another resin bed in a second pass (loading about 3.5 column volumes) resulted in a protein concentration in the flow through of about 1.3 mg/mL. Therefore, using two passes of adsorption and operating the chromatography in counter current mode resulted in adsorption of about 90% of the available soy protein that could be absorbed from soy whey at pH 4.5.

Elution Flow Rate

The effect of elution flow rate was investigated at three different flow rates and the recovery data are shown in Table 3. The recovery of protein at low flow rates in duplicate experiments resulted in recoveries of over 164% and 200%. The data indicate that eluting at 20 and 30 mL/min (11.3 and 17.0 cm/min, respectively) did not significantly affect the recoveries. Moreover, operating at higher flow rates achieved much faster elution (see FIG. 10), however at these higher flow rates a larger column volume of eluate was required to complete the elution (see FIG. 11). The need for a larger column volume of eluate was overcome by recycling the eluate which also reduced the total volume required for elution and also presented a more concentrated protein stream to the downstream ultrafiltration unit, reducing the membrane area needed for protein concentration.

TABLE 3
Elution and recovery of bound soy whey proteins at three different
flow rates.

| | ELUTION FLOW RATES | | |
|---|---|---|---|
| | 15 mL/min | 20 mL/min | 30 mL/min |
| Protein adsorbed | 75.4 ± 4.4 | 70.8 ± 2.7 | 72.9 ± 4.8 |
| (mg) | | | |
| Protein eluted | 139.7 ± 22.9 | 73.2 ± 1.5 | 68.4 ± 6.8 |
| (mg) | | | |
| Recovery (%) | 184.2 ± 19.7 | 103.4 ± 6.1 | 93.8 ± 15.6 |

Protein adsorption was calculated as the difference in the protein content in the feed and flow through by mass balance.

### Example 5

### Capture of Bulk Soy Whey Protein from a Pre-Treated Whey Process (PT)

The feed stream to the process, pre-treated whey protein, (also referred to PT whey) had approximately 1.4%-2.0% solids. It was comprised of approximately 18% minerals, 18% protein, and 74% sugars and other materials. Implementation of a Nanofiltration (NF) process allowed for water removal while retaining most of the sugars and protein, and other solid material, in the process to be recovered downstream. The NF membranes (Alfa Laval NF99 8038/48) for the trial were polyamide type thin film composite on polyester membranes with a 2 kDa molecular weight cutoff (MWCO) that allowed water, monovalent cations, and a very small amount of sugars and protein to pass through the pores. The membrane housing held 3 membrane elements. Each element was 8 inches in diameter and had 26.4 square meters of membrane surface area. The total membrane surface area for the process was 79.2 square meters. These membranes were stable up to 1 bar of pressure drop across each membrane element. For the entire module containing 3 membrane elements, a pressure drop of 3 bar was the maximum allowable. The NF feed rate of PT whey was approximately 2,500 L/hour. The temperature of this feed was approximately 45-50° C., and the temperature of the NF operation was regulated to be in this range using cooling water. Initial product flux rates were approximately 16-22 liters per meter squared per hour (LMH). The feed pressure at the inlet of the module was approximately 6 bar. Through the duration of the 6 hour run, the flux dropped as a result of fouling. The feed pressure was increased incrementally to maintain higher flux, but as fouling occurred, the pressure was increased to the maximum, and the flux slowly tapered from that point. Volumetric concentration factors were between 2× and approximately 4×.

A Precipitation step was performed to separate, e.g., phosphorous and calcium salts and complexes from the PT whey. Precipitation conditions were at pH 9 while maintaining the temperature at 45° C. with a residence time of approximately 15 minutes. The precipitation process occurred in a 1000 liter. This tank had multiple inlets and outlets where materials can be piped into and out of it. A small centrifugal pump circulated product out of the tank and back into the side of the tank to promote agitation and effective mixing of the 35% NaOH added to the system to maintain the target pH. This pump also sent product into the centrifuge when one of the T-valves connected to this recirculation loop was opened. Concentrated PT whey from the NF was fed directly into the top of the tank. 35% NaOH was connected into the feed line from the NF in order to control the pH at the target value. PT whey was fed into this mixing tank at approximately 2,500 L/hour and fed out at the same rate.

In following process step, an Alfa Laval Disc Centrifuge (Clara 80) with intermittent solids ejection system was used to separate precipitated solids (including insoluble soy fiber, insoluble soy protein) from the rest of the sugar- and protein-containing whey stream. In this process, concentrated PT whey from the precipitation tank was pumped into a disc-centrifuge where this suspension was rotated and accelerated by centrifugal force. The heavier fraction (precipitated solids) settles on the walls of the rotating centrifuge bowl with the lighter fraction (soluble liquid) was clarified through the use of disc-stacks and continuously discharged for the next step of the process. The separated precipitated solids was discharged at a regular interval (typically between 1 and 10 minutes). The clarified whey stream was less than 0.2% solids on a volumetric basis. The continuous feed flow rate was approximately 2.5 m3/hr, with a pH of 9.0 and 45° C. The insoluble fraction reached Ash=30-60%; Na=0.5-1.5% dry basis, K=1.5-3% dry basis, Ca=6-9% dry basis, Mg=3-6% dry basis, P=10-15% dry basis, Cl=1-2% dry basis, Fe, Mn, Zn, Cu<0.15% dry basis. Changes to the soluble fraction were as follows: Phytic acid was approximately 0.3% dry basis (85% reduction, P=0.2-0.3% dry basis (85-90% reduction), Ca=0.35-0.45% dry basis (80-85% reduction), Mg=0.75-0.85% dry basis (15-20% reduction).

The next step was an Ultrafiltration (UF) membrane. Protein was concentrated by being retained by a membrane while other smaller solutes pass into the permeated stream. From the centrifuge a diluted stream the containing protein, minerals and sugars was fed to the UF. The UF equipment and the membrane were supplied from Alfa Laval while the CIP chemicals came from Ecolab, Inc. The tested membrane, GR70PP/80 from Alfa-Laval, had a MWCO of 10kD and was constructed of polyethersulfone (PES) cast onto a polypropylene polymer backing. The feed pressure varied throughout the trial from 1-7 bar, depending upon the degree of fouling of the membranes. The temperature was controlled to approximately 65° C. The system was a feed and bleed setup, where the retentate was recycled back to the feed tank while the permeate proceeded on to the next step in the process. The system was operated until a volume concentration factor of 30× was reached. The feed rate to the UF was approximately 1,600 L/hour. The setup had the ability to house 3 tubes worth of 6.3″ membrane elements. However, only one of the three tubes was used. The membrane skid had an automatic control system that allowed control of the temperature, operating pressures (inlet, outlet, and differential) and volume concentration factor during process. Once the process reached the target volume concentration factor, typically after 6-8 hours of operation, the retentate was diafiltered (DF) with one cubic meter of water, (approximately 5 parts of diafiltration water per part of concentrated retentate) to yield a high protein retentate. After a processing cycle, the system was cleaned with a typical CIP protocol used with most protein purification processes. The retentate contained about 80% dry basis protein after diafiltration.

The permeate of the UF/DF steps contained the sugars and was further concentrated in a Reverse Osmosis Membrane system (RO). The UF permeate was transferred to an RO system to concentrate the feed stream from approximately 2% total solids (TS) to 20% TS. The process equipment and membranes (RO98pHt) for the RO unit operation were supplied by Alfa-Laval. The feed pressure was increased in order to maintain a constant flux, up to 45 bar at a temperature of 50° C. Typically each batch started at a 2-3% Brix and end at 20-25% Brix (Brix=sugar concentration).

After the RO step the concentrated sugar stream was fed to an Electrodialysis Membrane (ED). Electrodialysis from Eurodia Industrie SA removes minerals from the sugar solution. The electrodialysis process has two product streams. One is the product, or diluate, stream which was further processed to concentrate and pasteurize the SOS concentrate solution. The other stream from the electrodialysis process is a brine solution which contains the minerals that were removed from the feed stream. The trial achieved >80% reduction in conductivity, resulting in a product stream that measured <3 mS/cm conductivity. The batch feed volume was approx 40 liters at a temperature of 40° C. and a pH of 7. The ED unit operated at 18V and had up to 50 cells as a stack size.

The de-mineralized sugar stream from the ED was further processed in an Evaporation step. The evaporation of the SOS stream was carried out on Anhydro's Lab E vacuum evaporator. SOS product was evaporated to 40-75% dry matter with a boiling temperature of approximately 50-55° C. and a ΔT of 5-20° C.

A Spray Dryer was used to dry UF/DF retentate suspension. The UF diafiltrate retentate, with a solids content of approximately 8%, was kept stirred in a tank. The suspension was then fed directly to the spray dryer where it was combined with heated air under pressure and then sprayed through a nozzle. The dryer removed the water from the suspension and generated a dry powder, which was collected in a bucket after it was separated from the air stream in a cyclone. The feed suspension was thermally treated at 150° C. for 9 seconds before it entered the spray dryer to kill the microbiological organisms. The spray dryer was a Production Minor from the company Niro/GEA. The dryer was set up with co-current flow and a two fluid nozzle. The drying conditions varied somewhat during the trial. Feed temperatures were about 80° C., nozzle pressure was about 4 bars, and inlet air temperatures was about 250° C.

### Example 6

### Capture of Bulk Soy Whey Protein Whey Pre-Treatment Process and Cross-Flow Filtration Membranes

Approximately 8000 lbs of aqueous soy whey (also referred to as raw whey) at 110° F. and 4.57 pH from an isolated soy protein extraction and isoelectric precipitation continuous process was fed to a reaction vessel where the pH was increased to 5.3 by the addition of 50% sodium hydroxide. The pH-adjusted raw whey was then fed to a second reaction vessel with a 10 minute average residence time in a continuous process where the temperature was increased to 190° F. by the direct injection of steam. The heated and pH-adjusted raw whey was then cooled to 90 degrees F. by passing through a plate and frame heat exchanger with chilled water as the cooling medium. The cooled raw whey was then fed into an Alfa Laval VNPX510 clarifying centrifuge where the suspended solids, predominantly insoluble large molecular weight proteins, were separated and discharged in the underflow to waste and the clarified centrate proceeded to the next reaction vessel. The pH of the clarified centrate, or pre-treated whey protein, was adjusted to 8.0 using 12.5% sodium hydroxide and held for 10 minutes prior to being fed into an Alfa Laval VNPX510 clarifying centrifuge where the suspended solids, predominantly insoluble minerals, were separated and discharged in the underflow to waste. The clarified centrate proceeded to a surge tank prior to ultrafiltration. Ultrafiltration of the clarified centrate proceeded in a feed and bleed mode at 90° F. using 3.8″ diameter polyethersulfone spiral membranes, PW3838C, made by GE Osmonics, with a 10 kDa molecular weight cut-off. Ultrafiltration continued until a 60× concentration of the initial feed volume was accomplished, which required about 4.5 hrs. The retentate, 114 lbs at 4.5% total solids and 8.2 pH, was transferred to a reaction vessel where the pH was adjusted to 7.4 using 35% hydrochloric acid. The retentate was then heated to 305° F. for 9 seconds via direct steam injection prior to flash cooling to 140° F. in a vacuum chamber. The material was then homogenized by pumping through a homogenizing valve at 6000 psi inlet and 2500 outlet pressure prior to entering the spray drier through a nozzle and orifice combination in order to atomize the solution. The spray drier was operated at 538° F. inlet temperature and 197° F. outlet temperature, and consisted of a drying chamber, cyclone and baghouse. The spray dried soy whey protein, a total of 4 lbs, was collected from the cyclone bottom discharge.

### Example 7

### Capture of Bulk Soy Whey Protein Using Expanded Bed Adsorption (EBA) Chromatography

200 ml of aqueous raw soy whey (not pre-treated) with a total solids content of 1.92%, was adjusted to pH 4.5 with acetic acid and applied to a 1×25 cm column of Mimo6ME resin (UpFront Chromatography, Copenhagen Denmark) equilibrated in 10 mM sodium citrate, pH 4.5. Material was loaded onto the column from the bottom up at 20-25° C. using a linear flow rate of 7.5 cm/min. Samples of the column flow-through were collected at regular intervals for later analysis. Unbound material was washed free of the column with 10 column volumes of equilibration buffer, then bound material recovered by elution with 50 mM sodium hydroxide. 10 μls of each fraction recovered during EBA chromatography of aqueous soy whey were separated on a 4-12% SDS-PAGE gel and stained with Coomassie Brilliant Blue R 250 stain. SDS-PAGE analysis of the column load, flow-through, wash, and sodium hydroxide eluate samples is depicted in FIG. 12. As used in FIG. 12, RM: raw material (column load); RT1-4: column flow-through (run through) collected at equal intervals during the load; total: the total run-through fraction; W: column wash; E: column eluate. Binding was reasonably efficient, as very little protein is seen in the initial breakthrough fractions, only showing up in the later fractions. A total of 662 mg of protein was recovered in the eluate, for a yield of 3.3 mg/ml of starting material. Under these conditions, the capacity of this resin was shown to be 33.1 mg of protein per ml of adsorbent.

### Example 8

### Capture of Bulk Soy Whey Protein from Spray-Dried SWP Using Expanded Bed Adsorption (EBA) Chromatography

Spray-dried soy whey powder was slurried to a concentration of 10 mg/ml in water and adjusted to pH 4.0 with acetic acid. 400 ml of the slurry was then applied directly to the bottom of a 1×25 cm column of Mimo-4SE resin (UpFront Chromatography, Copenhagen Denmark) that had been equilibrated in 10 mM sodium citrate, pH 4.0. Material was loaded at 20-25° C. using a linear flow rate of 7.5 cm/min. Samples of the column flow-through were collected at regular intervals for later analysis. Unbound material was washed free of the column using 10 column volumes of equilibration buffer. Bound material was eluted with 30 mM NaOH. 10 μls of each fraction recovered during EBA chromatography of a suspension of soy whey powder were separated on a 4-12% SDS-PAGE gel and stained with Coomassie Brilliant Blue R 250 stain. SDS-PAGE analysis of the column load, flow-thru, wash, and eluate are depicted in FIG. 13. As used in FIG. 13, RM: raw material (column load); RT1-4: column flow-through (run through) collected at equal intervals during the load; total: the total run-through fraction; W: column wash; E: column eluate. Binding was not as efficient as was observed using the Mimo6ME resin, as several protein bands are seen in the breakthrough fractions. A total of 2070 mg of protein were recovered in the eluate, for a yield of 5.2 mg/ml of starting material. Under these conditions, the capacity of this resin was shown to be 104 mg of protein per ml of adsorbent.

### Example 9

### Removal of KTI from Bulk Soy Whey Protein Using Expanded Bed Adsorption (EBA) Chromatography

Two procedures were used to remove the majority of contaminating KTI protein from the bulk of the soy whey protein by EBA chromatography. In the first, 200 ml of aqueous raw soy whey (not pre-treated) with a total solids content of 1.92%, was adjusted to pH 6.0 with sodium hydroxide and applied to a 1×25 cm column of Mimo6HE resin (UpFront Chromatography, Copenhagen Denmark) equilibrated in 10 mM sodium citrate, pH 6.0. Material was loaded onto the column from the bottom up at 20-25° C. using a linear flow rate of 7.5 cm/min. Samples of column flow-through were collected at regular intervals for later analysis. Unbound material was washed free of the column with 10 column volumes of equilibration buffer, then bound material recovered by elution with 30 mM sodium hydroxide. 10 μls of each fraction recovered during EBA chromatography of a suspension of soy whey powder were separated on a 4-12% SDS-PAGE gel and stained with Coomassie Brilliant Blue R 250 stain. SDS-PAGE analysis of the column load, flow-through, wash, and sodium hydroxide eluate samples is depicted in FIG. 14. As used in FIG. 14, RM: raw material (column load); RT1-4: flow-through material (run through) collected at equal intervals during the load; total: the total run-through fraction; W: column wash; E: column eluate. The bulk of the loaded protein is clearly seen eluting in the flow-through, while the bulk of the KTI protein remains bound to the resin. A total of 355 mg of protein, the bulk of which is KTI, was recovered in the eluate, for a yield of 1.8 mg/ml of starting material. Under these conditions, the capacity of this resin was shown to be 17.8 mg of KTI (plus minor contaminants) per ml of adsorbent.

In the second procedure, 160 mls of aqueous raw soy whey (not pre-treated) with a total solids content of 1.92%, was adjusted to pH 5.1 with acetic acid and applied to a 1×25 cm column of Mimo6ZE resin (UpFront Chromatography, Copenhagen Denmark) equilibrated in 10 mM sodium citrate, pH 5.0. Material was loaded onto the column from the bottom up at 20-25° C. using a linear flow rate of 7.5 cm/min. Samples of column flow-through were collected at regular intervals for later analysis. Unbound material was washed free of the column with 10 column volumes of equilibration buffer, then bound material recovered by elution with 30 mM sodium hydroxide. 10 μls of each fraction recovered during EBA chromatography of a suspension of soy whey powder were separated on a 4-12% SDS-PAGE gel and stained with Coomassie Brilliant Blue R 250 stain. SDS-PAGE analysis of the column load, flow-through, wash, and sodium hydroxide eluate samples is depicted in FIG. 15. As used in FIG. 15, RM: raw material (column load); RT1-4: flow-through material (run through) collected at equal intervals during the load; total: the total run-through fraction; W: column wash; E: column eluate. The bulk of the KTI is clearly seen eluting in the flow-through, while the bulk of the remaining protein remains bound to the resin. A total of 355 mg of soy protein essentially devoid of contaminating KTI was recovered in the eluate, for a yield of 2.1 mg/ml of starting material. Under these conditions, the capacity of this resin was shown to be 16.8 mg of soy protein per ml of adsorbent.

### Example 10

### Formation of a Non-Dairy Whipped Topping Containing a Foaming Agent Comprised of an Amount of Soy Whey Protein

A whipped topping dessert product was prepared using a foaming agent from soy whey protein as described hereinabove. Table 4 is the list of ingredients used to prepare a whipped topping dessert product having a foaming agent comprised of 0.50% of soy whey protein and 2.50% of soy whey protein, compared to a whipped topping prepared using egg white as the emulsifier.

TABLE 4
Whipped Topping Dessert Formulation with a Foaming Agent Comprised of Soy Whey
Protein vs. Whipped Topping Dessert Formulation with Egg Whites

| | 2.05% Caseinate | | 2.05% egg white | | 2.50% SWP | | 0.50% SWP | |
|---|---|---|---|---|---|---|---|---|
| | % | grams/ | % | grams/ | % | grams/ | % | grams/ |
| Ingredient | as | 1000 g | as | 1000 g | as | 1000 g | as | 1000 g |
| Water | 57.55 | 575.50 | 57.55 | 575.50 | 57.55 | 575.50 | 57.55 | 575.50 |
| Partially hydrogenated coconut oil | 27.00 | 270.00 | 27.00 | 270.00 | 27.00 | 270.00 | 27.00 | 270.00 |
| Sugar | 7.00 | 70.00 | 7.00 | 70.00 | 7.00 | 70.00 | 7.00 | 70.00 |
| Corn syrup solids, 25DE | 5.30 | 53.00 | 5.30 | 53.00 | 4.85 | 48.50 | 6.85 | 68.50 |
| SWP | 0.00 | 0.00 | 0.00 | 0.00 | 2.50 | 25.00 | 0.50 | 5.00 |
| Egg white solids | 0.00 | 0.00 | 2.05 | 20.50 | 0.00 | 0.00 | 0.00 | 0.00 |
| Sodium caseinate | 2.05 | 20.50 | 0.00 | 0.00 | 0.00 | 0.00 | 0.00 | 0.00 |
| mono- and diglyceride | | | | | | | | |
| (DIMODAN HSP-K) | 0.60 | 6.00 | 0.60 | 6.00 | 0.60 | 6.00 | 0.60 | 6.00 |
| DATEM (PANODAN FDPK) | 0.30 | 3.00 | 0.30 | 3.00 | 0.30 | 3.00 | 0.30 | 3.00 |
| polysorbate 60 (TWEEN 60) | 0.10 | 1.00 | 0.10 | 1.00 | 0.10 | 1.00 | 0.10 | 1.00 |
| Flavor: Givaudan IC Flavor | 0.10 | 1.00 | 0.10 | 1.00 | 0.10 | 1.00 | 0.10 | 1.00 |
| Total | 100.00 | 1000.00 | 100.00 | 1000.00 | 100.00 | 1000.00 | 100.00 | 1000.00 |

The whipped topping was prepared by first adding the soy whey protein to water that had been pre-heated to a temperature of 52° C. and mixing in a conventional food processing kettle (a stainless steel jacketed Groen TDC/3-20 kettle) (Groen, Jackson, Miss.)) equipped with air operated propeller mixer using moderate shear mixing until dispersed. The protein slurry was heated to a temperature of 77° C. and mixing speed was reduced to slow but continued for an additional 5 minutes. The sugar and corn syrup solids were added to the protein slurry and mixing continued for an additional 5 minutes. The water soluble emulsifiers DATEM (Danisco, Denmark) and Polysorbate 60 were added to the protein slurry and mixing continued for 2 minutes.

The coconut oil was melted at a temperature of 60° C. DIMODAN (Danisco, Denmark) was added to the melted coconut oil and mixed until dispersed. The oil/DIMODAN mixture was added to the protein slurry and the mixture was again mixed and heated to a temperature of between 75° C. to 77° C. until it was homogenous in appearance. Flavor was added and mixing continued for an additional 2 minutes.

The mixture was then pasteurized at a temperature of 74° C. for a hold time of 10 minutes. After pasteurization, the mixture was homogenized using a piston-type, 2 stage APV 15 MR. (SPX, Charlotte, N.C.) homogenizer set with 500 psi (34 BAR) pressure on the second stage and 1500 psi (103 BAR) pressure on the first stage. The whipping base mixture was cooled immediately to 4° C. and aged overnight (8-12 hours) before whipping.

To prepare the whipped topping samples for evaluation, 200 g of whipping base (base weight) was added to a chilled mixing bowl, a Hobart mixing bowl (Hobart Corp., Troy, Ohio). The base was whipped in the mixer on speed 6 for 5½ minutes until a foam was formed. The foam was filled into 7 oz cups and weighed (whipped weight). The cups were turned upside down over a glass funnel and observed for 1 hour. The amount of melted foam after 1 hour was measured.

The whipped topping samples prepared with the foaming agent from soy whey protein (0.50% SWP and 2.50% SWP) were evaluated against the whipped topping sample comprised of egg white solids, and the whipped topping sample comprised of caseinate. Results of the evaluation are set forth in Table 5.

TABLE 5
Foaming Comparison of Whipped Topping with Foaming Agent
Comprised of Soy Whey Protein to Whipped Topping Prepared with
Egg White Solids, and to Whipped Topping Prepared with Caseinate.

| | Base | Whipped | | |
|---|---|---|---|---|
| Sample | Weight | Weight | Overrun | Comments |
| 2.50% SWP | 200 | 86.9 | 130.15 | Foam not very stable. |
| | | | | Poured right through |
| | | | | funnel immediately. |
| 0.50% SWP | 200 | 55 | 263.64 | Stable foam. Foam never |
| | | | | dripped after 1 hour |
| 2.05% egg | 200 | 61.51 | 225.15 | Stable foam. Foam never |
| white solids | | | | dripped after 1 hour |
| 2.05% Na | 200 | 68.27 | 192.95% | foam runnier than egg |
| Caseinate | | | | whites or SWP but still |
| | | | | stiff |

The whipped topping samples that were prepared with a foaming agent comprising a low amount of soy whey protein (i.e., 0.50% soy whey protein) not only retained the same sensory properties (e.g., taste, structure, aroma, and mouthfeel) of whipped toppings currently in the market (e.g., Cool-Whip®) but the topping made with a foaming agent comprised of a lower amount of SWP (0.50%) produced stable foam similar to the topping containing egg white solids (2.05%), as it did not flow after more than an hour in an inverted cup. FIG. 16 depicts a whipped topping sample prepared with a foaming agent comprising 0.50% soy whey protein.

### Example 11

### Formation of a Meringue Containing a Foaming Agent Comprised of an Amount of Soy Whey Protein

A meringue product was prepared using a foaming agent comprised of soy whey protein as described hereinabove. Table 6 is the list of ingredients used to prepare a meringue product having a foaming agent comprised of 0.5% of soy whey protein substituted for 50% of the egg whites and 1% of soy whey protein substituted for 50% of the egg whites, compared to a meringue prepared using 100% egg whites.

TABLE 6
Meringue Formulation with a Foaming Agent Comprised
of Soy Whey Protein

| | 50% Egg whites | | 50% Egg whites | |
|---|---|---|---|---|
| | 0.50% SWP | | 1.00% SWP | |
| Ingredient | % | gms | % | gms |
| Egg white - liquid CEP | 18.67 | 56.01 | 18.67 | 56.01 |
| Soy Whey Protein | 0.50 | 1.50 | 1.00 | 3.00 |
| Water | 16.35 | 49.05 | 16.35 | 49.05 |
| Maltodextrin 10-15DE | 1.82 | 5.46 | 1.32 | 3.96 |
| Sugar (Baker's Special | 62.25 | 186.75 | 62.25 | 186.75 |
| Sugar) | | | | |
| Cream of Tartar | 0.31 | 0.93 | 0.31 | 0.93 |
| Flavor | 0.10 | 0.30 | 0.10 | 0.30 |
| Total | 100.00 | 300.00 | 100.00 | 300.00 |

The meringue was prepared by first pre-heating an oven to 95° C. and placing the rack in the center of the oven. A baking sheet was lined with parchment paper. The egg whites and soy whey protein were placed in a mixing bowl (a Hobart mixing bowl) with a whisk attachment and beat on low-medium speed until foamy. The cream of tartar was added to the egg whites and beating continued until the meringue held soft peaks. The sugar was gradually added and beating continued on medium-high speed until the meringue held very stiff peaks. Flavor was beat into the meringue. The meringue was considered done when it held stiff peaks and did not feel gritty when a small amount was rubbed between a thumb and index finger.

The meringue was spooned onto the lined sheets using two spoons and forming into mounds. The meringues were baked for approximately 1.5 to 1.75 hours in a Metro C5 3 Series oven (Metro Supply and Equipment, Alton, Ill.). The baking sheet was rotated from front to back about half way through baking time to ensure even baking. The meringues were considered to be done when they were pale in color and fairly crisp, releasing easily from the parchment paper.

The oven was turned off but the finished meringues were left on the baking sheet in the oven for several hours or overnight (8-12 hours) with the oven door open a crack to complete the drying process. Once dry, the meringues were covered and stored at room temperature for several days.

Meringue samples were prepared with a foaming agent comprised of soy whey protein as a replacement for 50.00% of the egg whites (i.e., 0.50% soy whey protein and 1.00% soy whey protein). These samples retained the same sensory properties (e.g., taste, structure, aroma, and mouthfeel) of typical meringue products currently in the market. FIG. 17 depicts a meringue sample prepared with a foaming agent comprising an amount of soy whey protein.

### Example 12

### Formation of a Pound Cake Containing a Foaming Agent Comprised of an Amount of Soy Whey Protein

A pound cake was prepared using a foaming agent comprised of soy whey protein as described hereinabove. Table 7 is the list of ingredients used to prepare a pound cake product having a foaming agent comprised of 0.50% soy whey protein substituted for 50.00% of the eggs, 1.00% soy whey protein substituted for 50.00% of the eggs, and 1.50% soy whey protein substituted for 50.00% of the eggs, compared to a pound cake prepared using 100.00% whole eggs.

TABLE 7
Pound Cake Formulation with a Foaming Agent Comprised of Soy Whey
Protein Substituted for 50% Eggs vs. Pound Cake Formulation with 100% Eggs

| | Control | | 50% Eggs | | 50% Eggs | | 50% Eggs | |
|---|---|---|---|---|---|---|---|---|
| | (100% Eggs) | | 0.5% SWP | | 1% SWP | | 1.5% SWP | |
| Ingredient | % | Gms | % | gms | % | gms | % | gms |
| Cake Flour | 25.790 | 206.320 | 25.790 | 206.320 | 25.790 | 206.320 | 25.790 | 206.320 |
| Sugar | 25.790 | 206.320 | 25.790 | 206.320 | 25.790 | 206.320 | 25.790 | 206.320 |
| Maltodextrin | 0.000 | 0.000 | 2.514 | 20.110 | 2.014 | 16.110 | 1.514 | 12.110 |
| 10-15DE | | | | | | | | |
| Soy Whey | 0.000 | 0.000 | 0.500 | 4.000 | 1.000 | 8.000 | 1.500 | 12.000 |
| Protein | | | | | | | | |
| Water | 0.000 | 0.000 | 9.041 | 72.330 | 9.041 | 72.330 | 9.041 | 72.330 |
| Whole Eggs | 24.110 | 192.910 | 12.055 | 96.440 | 12.055 | 96.440 | 12.055 | 96.440 |
| Butter (unsalted) | 21.920 | 175.360 | 21.920 | 175.370 | 21.920 | 175.370 | 21.920 | 175.370 |
| Liquid Milk | 1.680 | 13.410 | 1.680 | 13.440 | 1.680 | 13.440 | 1.680 | 13.440 |
| Salt | 0.710 | 5.680 | 0.710 | 5.670 | 0.710 | 5.670 | 0.710 | 5.670 |
| Total | 100.000 | 800.000 | 100.000 | 800.000 | 100.000 | 800.000 | 100.000 | 800.000 |

The pound cake was prepared by first bringing all of the ingredients to room temperature, particularly the butter, eggs and all of the liquid ingredients. The dry ingredients (cake flower, salt, soy whey protein, and maltodextrin) were sifted and set aside.

The butter was placed into a mixing bowl (a Hobart HL 120 Mixing bowl), having a paddle attachment, and was slowly beat until smooth, fluffy, light and creamy (about 3 minutes). The sugar was added to the butter and the mixture was creamed at speed #2 until light and fluffy (about 4 minutes). The sides of the bowl were scraped down with a rubber spatula. The eggs were added to the creamed mixture in small portions and beat into the mixture until fully incorporated after each addition (about 2 minutes each). Flavorings were then added.

The sides of the bowl were scraped down with a rubber spatula to ensure even mixing. The dry ingredients were added to the mixture on an alternating basis with the remaining liquid ingredients (water, liquid milk) according to the following system: ¼ of the dry ingredients were added and mixed just until blended, followed by adding ⅓ of the liquid ingredients and mixing just until blended; this system was repeated until all of the ingredients were used. The sides of the bowl were occasionally scraped down with a rubber spatula to ensure even mixing.

680 grams of the batter was immediately scaled and poured into a 7×11×22 cm baking pan that had been greased and lined with parchment paper. The pan was placed in a 162° C. Metro C5 3 Series oven for 65 minutes.

The physical characteristics of the baked pound cakes (with and without the foaming agent comprised of soy whey protein) were observed and are listed in Table 8.

TABLE 8
Physical Characteristic Comparison of Pound Cakes Made with a
Foaming Agent Comprised of Soy Whey Protein to Pound Cake
Made Without a Foaming Agent Comprised of Soy Whey Protein

| | Batter | Specific | Bake time | Yield | Height | Moisture |
|---|---|---|---|---|---|---|
| Sample | temp (° C.) | gravity | (min) | (%) | (cm) | (%) |
| Control | 21.7° C. | 0.828 | 65 | 6.8 | 7.7 | 21.13 |
| (100% eggs) | (71° F.) | | | | | |
| 50% eggs + | 21.1° C. | 0.921 | 70 | 6.9 | 6.8 | 20.64 |
| 0.5% SWP | | | | | | |
| 50% eggs + | 21.7° C. | 0.920 | 70 | 7.1 | 6.9 | 20.42 |
| 1% SWP | (71° F.) | | | | | |
| 50% eggs + | 21.1° C. | 0.930 | 70 | 6.6 | 6.6 | 20.58 |
| 1.5% SWP | (70° F.) | | | | | |

Pound cake samples were prepared with 50% of the eggs replaced with a foaming agent comprised of various amounts of soy whey protein (i.e., 0.500% soy whey protein, 1.000% soy whey protein, and 1.500% soy whey protein). These samples retained the same sensory properties (e.g., taste, structure, aroma, and mouthfeel) of typical pound cake products currently in the market. FIG. 18 depicts a pound cake sample prepared with a foaming agent comprising an amount of soy whey protein.

### Example 13

### Formation of a Sorbet without Fruit Pulp Containing a Foaming Agent Comprised of an Amount of Soy Whey Protein

A sorbet product was prepared using a foaming agent from soy whey protein as described hereinabove. Table 9 is the list of ingredients used to prepare a sorbet having a foaming agent comprised of 0.05% soy whey protein, 0.10% soy whey protein, and 0.20% soy whey protein compared to a sorbet made with 0.10% whey powder concentrate (WPC). The soy whey protein as a foaming agent was tested in a standard sorbet formulation, as shown in Table 9. The WPC was used as a reference foaming agent. SWP was tested in different dosages alone and in combination with different emulsifiers (mono- and diglycerides and SSL). SWP was also tested as a foaming agent in an alcohol-containing sorbet, which would be considered a difficult system to aerate.

TABLE 9
Sorbet Formulation with a Foaming Agent Comprised of Soy Whey Protein
(SWP) vs. Sorbet Formulation with Whey Powder Concentrate (WPC)*

| | Control | | | | | | |
|---|---|---|---|---|---|---|---|
| | (WPC) | SWP | | | | | |
| | 1 | 2 | 3 | 4 | 5 | 6 | 7 |
| Ingredient: | % | % | % | % | % | % | % |
| Water | 69.58 | 69.63 | 69.58 | 69.48 | 69.38 | 69.48 | 64.58 |
| Sucrose | 25.00 | 25.00 | 25.00 | 25.00 | 25.00 | 25.00 | 25.00 |
| Glucose syrup powder | 5.00 | 5.00 | 5.00 | 5.00 | 5.00 | 5.00 | 5.00 |
| (32 DE, 95% TS) | | | | | | | |
| Flavor (Firmenich | 0.02 | 0.02 | 0.02 | 0.02 | 0.02 | 0.02 | 0.02 |
| Lemon 504196 A) | | | | | | | |
| WPC (80% protein) | 0.10 | | | | | | |
| SWP | | 0.05 | 0.10 | 0.20 | 0.10 | 0.10 | 0.10 |
| Mono- and diglyceride | | | | | 0.20 | | |
| (CREMODAN ® SUPER) | | | | | | | |
| SSL P 55 | | | | | | 0.10 | |
| (GRINDSTED ®) | | | | | | | |
| LBG 246 | 0.20 | 0.20 | 0.20 | 0.20 | 0.20 | 0.20 | 0.20 |
| (GRINDSTED ®) | | | | | | | |
| Flavor (Firmenich | 0.10 | 0.10 | 0.10 | 0.10 | 0.10 | 0.10 | 0.10 |
| Lemon 503991 T) | | | | | | | |
| Vodka | | | | | | | 5.00 |
| Total | 100.00 | 100.00 | 100.00 | 100.00 | 100.00 | 100.00 | 100.00 |

*Whey Powder Concentrate is the same as Whey Protein Concentrate (WPC)

The sorbet was prepared by first mixing the liquid ingredients (water and vodka, when used) at 20-22° C. to form a liquid mix. Next the dry ingredients were mixed together (whey powder concentrate or soy whey protein, sucrose, glucose syrup powder, LBG, and emulsifier (mono- and diglycerides or SSL)) to form a dry mix. The dry mix and the liquid mix where then mixed together to form a mixture and the temperature was increased to 70° C. When an emulsifier was included in the mixture, the mixture was homogenized at 78° C. at 150 BAR. The mixture was then pasteurized at 84° C. for 30 seconds. After pasteurization, the mixture was cooled to 5° C. The mixture was aged overnight (24 hours) in ice water (2-5° C.). Next, citric acid (50% solution) was added to the mixture to get to a pH of 3. Once the pH is at 3, flavouring was added by mixing it into the mixture for 5 minutes. The mixture was then frozen with light extrusion with a target overrun of 80%, shown in Table 10. The sorbet was filled into packaging. The sorbet was hardened in a hardening tunnel at −40° C. for 2 hours. After hardening, the sorbet was stored at −20° C. in a cabinet-freezer.

TABLE 10
Obtainable Overrun:

| | 1 | 2 | 3 | 4 | 5 | 6 | 7 |
|---|---|---|---|---|---|---|---|
| % | 80 | 80 | 80 | 80 | 90 | 80 | 80 |
| Overrun | | | | | | | |

In general, the samples showed very good foamability, as shown in Table 10, above.

Soy whey protein showed very good foamability in all tested dosages. In combination with mono- and diglyceride, a 12% increase in overrun was obtained.

Alcohol does not destroy the whipping capacity of SWP, which is surprising since an alcohol containing sorbet is a difficult system to aerate.

The finished sorbet was analyzed for:

Meltdown Determination—

The melting rate (drip rate) was done according to Technical Memorandum No. 2520 from DuPont Nutrition & Health. A rectangular piece of sorbet (125 cc, dimension: approximately 100 mm×50 mm×25 mm), which had been stored at −18° C. for at least 24 hours, was weighed and placed on a grid. The room, in which the melting took place, was kept at a constant temperature of 22° C.+/−1° C. The grid was placed above a 500 ml glass beaker placed on an analytical balance. The analytical balances were linked to a computer which made continuous registrations (one measurement every 2 minutes) and calculated the amount of melted sorbet as a function of time.

Course of Melt Down—

SWP at the lowest tested dosage (0.05%) gave similar melting resistance to the reference with 0.1% WPC. Dosed similarly to or higher than WPC, it gave better melting resistance. Adding alcohol to the sample with 0.1% SWP, gave poorer melting resistance, as did addition of any of the three emulsifiers tested, albeit not to the same extent. The fastest melting was seen in the sample with SWP and mono- and diglycerides. All other samples had comparable melting resistance.

Heat Shock Stability Testing—

Heat shock testing was done according to method described in Technical Memorandum No. 2524 from DuPont Nutrition & Health. The sorbet samples were tempered and stored in a freezer cabinet at −18° C. The tempered products were placed in a heat shock freezer cabinet with a temperature varying between −20° C. and −5° C. every 6 hours. The sorbet samples were kept in this freezer cabinet for 7 days (2). All samples, both fresh and heat shock-treated, were tempered at −18° C. for 2 days before being sensory analyzed.

Sensory Testing:

Sensory Evaluation—

Trained people from the ice cream group evaluated the sorbets. Both fresh (not heat shock-treated) and heat shock-treated samples were evaluated, shown in Table 11.

TABLE 11
Sensory Testing

| Sample | Fresh samples | Heat shocked samples |
|---|---|---|
| 1 | Reference. Light colour, good air cell | Cold, poor air cell |
| | distribution. | distribution |
| 2 | Less creamy, slightly colder than the | Colder and more |
| | reference | icy than ref |
| 3 | Similar to reference | Slightly cold and icy |
| 4 | Very smooth, creamy and viscous in | Good heat shock |
| | the mouth. Very good air cell | stability, less |
| | distribution. | cold than reference |
| 5 | Brittle, very fine air cells. More | Good air cell |
| | smooth than reference. | distribution, very brittle |
| 6 | Fresh and cold but still creamy and | Fresh |
| | smooth. | |
| 7 | Fine air cell distribution. | Slightly cold, better |
| | | than reference |

A very good air cell distribution provided by the SWP also gave very smooth and creamy sorbet in the fresh samples.

SWP in combination with SSL gave very creamy and smooth, yet cold and fresh-eating sorbet. The combination of creamy and fresh are not common, thus this is an interesting result and yields a surprising new texture in sorbet.

Heat shocked samples performed similar to the fresh samples, but were all colder and icier than the fresh samples. Compared to the Control (WPC), the SWP samples had the same or better quality after heat shocking.

### Example 14

### Formation of a Sorbet with Fruit Pulp Containing a Foaming Agent Comprised of an Amount of Soy Whey Protein

The good results obtained in Example 13 lead to trial formulae in a more stressed system with a high dosage of mango puree and without added stabilizer (LBG), shown in Table 12 below. Mango puree is known to yield problems with foaming or whipping in sorbet. SWP was tested as the only foaming agent and in combination with mono- and diglycerides.

TABLE 12
Sorbet Formulation with a Foaming Agent Comprised of
Soy Whey Protein (SWP) with Mango Puree

| | SWP | | | | |
|---|---|---|---|---|---|
| | 8 | 9 | 10 | 11 | 12 |
| Ingredient: | % | % | % | % | % |
| Water (Tap) | 59.615 | 59.515 | 59.615 | 59.715 | 59.765 |
| Sucrose | 20.000 | 20.000 | 20.000 | 20.000 | 20.000 |
| Glucose syrup powder | 5.000 | 5.000 | 5.000 | 5.000 | 5.000 |
| (32 DE, 95% TS) | | | | | |
| Mango puree 28 brix | 15.000 | 15.000 | 15.000 | 15.000 | 15.000 |
| SWP | | 0.100 | 0.200 | 0.100 | 0.050 |
| Mono- and diglyceride | 0.200 | 0.200 | | | 0.20 |
| (CREMODAN ® | | | | | |
| SUPER) | | | | | |
| Flavor (Firmenich | 0.010 | 0.010 | 0.010 | 0.010 | 0.010 |
| Mango 051864 A) | | | | | |
| Natural Yellow Flavor | 0.175 | 0.175 | 0.175 | 0.175 | 0.175 |
| (Annatto Extract, | | | | | |
| Danisco) | | | | | |
| Total | 100.00 | 100.00 | 100.00 | 100.00 | 100.00 |

The sorbet was prepared by first mixing the liquid ingredients (water and mango puree) at 20-22° C. to form a liquid mix. Next the dry ingredients were mixed together (sucrose, glucose syrup powder, whey powder concentrate or soy whey protein, emulsifier (mono- and diglycerides)) to form a dry mix. The dry mix and the liquid mix where then mixed together to form a mixture and the temperature was increased to 70° C. The mixture was homogenized at 78° C. at 150 BAR. The mixture was then pasteurized at 84° C. for 30 seconds. After pasteurization, the mixture was cooled to 5° C. The mixture was aged overnight (24 hours) in ice water (2-5° C.). Next, citric acid (50% solution) was added to the mixture to get to a pH of 3.7. Once the pH is at 3.7, flavouring and colouring were added by mixing them into the mixture for 2 minutes.

Viscosity—

the viscosity was measured on a Brookfield LVT at a speed of 30 rpm for 30 seconds, spindle S62 at a temperature of 5° C., see Table 13, below.

TABLE 13
Mix viscosity:

| | 8 | 9 | 10 | 11 | 12 |
|---|---|---|---|---|---|
| Viscosity | 230 | 230 | 190 | 240 | 240 |
| CP | | | | | |

All mixes exhibited similar rheological properties.

The mixture was then frozen with light extrusion with target overrun of 100%, see Table 14, below. The sorbet was filled into packaging and hardened in a hardening tunnel at −40° C. for 2 hours. The sorbet was stored at −20° C. in a cabinet-freezer.

TABLE 14
Obtainable Overrun

| | 8 | 9 | 10 | 11 | 12 |
|---|---|---|---|---|---|
| % | 50 | 80 | 100 | 90 | 60 |
| Overrun | | | | | |

In general, the samples showed very good foamability, as shown in Table 14, above.

Soy whey protein showed very good foamability in all tested dosages. In combination with mono- and diglyceride, it whipped even better than alone. Thus SWP showed excellent whipping properties in stressed systems like sorbet with a high content of mango puree.

The high dosage of SWP was the only system that was able to whip/foam the stressed system to 100% overrun (OR). The addition of mono-di glycerides reduced the foaming properties of SWP.

The finished sorbet was analyzed for:

Meltdown Determination—

The melting rate (drip rate) was done according to Technical Memorandum No. 2520 from DuPont Nutrition & Health. A rectangular piece of sorbet (125 cc, dimension: approximately 100 mm×50 mm×25 mm), which had been stored at −18° C. for at least 24 hours, was weighed and placed on a grid. The room, in which the melting took place, was kept at a constant temperature of 22° C.+/−1° C. The grid was placed above a 500 ml glass beaker placed on an analytical balance. The analytical balances were linked to a computer which made continuous registrations (one measurement every 2 minutes) and calculated the amount of melted sorbet as a function of time.

Course of Melt Down—

SWP gave acceptable melting resistance, at high levels the melt resistance improved.

Heat Shock Stability Testing—

Heat shock testing was done according to method described in Technical Memorandum No. 2524 from DuPont Nutrition & Health. The sorbet samples were tempered and stored in a freezer cabinet at −18° C. The tempered products were placed in a heat shock freezer cabinet with a temperature varying between −20° C. and −5° C. every 6 hours. The sorbet samples were kept in this freezer cabinet for 7 days (2). All samples, both fresh and heat shock-treated, were tempered at −18° C. for 2 days before being analyzed.

Sensory Testing:

Sensory Evaluation—

Trained people from the ice cream group evaluated the sorbets. Both fresh (not heat shock-treated) and heat shock-treated samples were evaluated, shown in Table 15.

TABLE 15
Sensory Testing

| Sample | Fresh samples | Heat shocked samples |
|---|---|---|
| 8 | Open, big visible air bubbles | Soft, poor air distribution |
| 9 | Open, big visible air bubbles, for the air | Crumbly, soft, slightly more pale |
| | that is incorporated (not visible) is finely | colour than sample no. 3 from |
| | incorporated, crumbly structure, falling | Example 13 |
| | apart | |
| 10 | Fine air incorporation, brittle | Good air distribution, very icy, |
| | | brittle, cold-eating |
| 11 | Inferior air incorporation compared to | Slightly less brittle than sample |
| | sample no. 5 from Example 13, less | no. 5 from Example 13 |
| | brittle than sample no. 5 | |
| 12 | Visible big air bubbles | Slightly less brittle |

### Example 15

### Determination of SSI

A sample of the protein material is obtained by accurately weighing out 12.5 g of protein material. 487.5 g of deionized water is added to a quart blender jar. 2 to 3 drops of defoamer (Dow Corning Antifoam B Emulsion, 1:1 dilution with water) is added to the deionized water in the blender jar. The blender jar containing the water and defoamer is placed on a blender (Osterizer), and the blender stirring speed is adjusted to create a moderate vortex (about 14,000 rpm). A timer is set for 90 seconds, and the protein sample is added to the water and defoamer over a period of 30 seconds while blending. Blending is continued for the remaining 60 seconds after addition of the protein sample (total blending time should be 90 seconds from the start of addition of the protein sample).

The resulting protein material sample/water/defoamer slurry is then transferred to a 500 ml beaker containing a magnetic stirring bar. The beaker is then covered with plastic wrap or aluminum foil. The covered beaker containing the slurry is then placed on a stirring plate, and the slurry is stirred at moderate speed for a period of 30 minutes.

200 g of the slurry is then transferred into a centrifuge tube. A second 200 g sample of the slurry is then transferred into a second centrifuge tube. The remaining portion of the slurry in the beaker is retained for measuring total solids. The 2 centrifuge tube samples are then centrifuged at 500×g for 10 minutes (1500 rpm on an IEC Model K). At least 50 ml of the supernatant is withdrawn from each centrifuge tube and placed in a plastic cup (one cup for each sample from each centrifuge tube, 2 total cups).

Soluble Solids is then determined by drying a 5 g sample of each supernatant at 130° C. for 2 hours, measuring the weights of the dried samples, and averaging the weights of the dried samples.

Total Solids is determined by drying two 5 g samples of the slurry retained in the beaker, measuring the weights of the dried samples, and averaging the weights of the dried samples.

The Soluble Solids Index (SSI) is calculated from the Soluble Solids and Total Solids according to the formula (Soluble Solids/Total Solids)×100.

One skilled in the art would readily appreciate that the methods, compositions, and products described herein are representative of exemplary embodiments, and not intended as limitations on the scope of the invention. It will be readily apparent to one skilled in the art that varying substitutions and modifications may be made to the present disclosure disclosed herein without departing from the scope and spirit of the invention.

All patents and publications mentioned in the specification are indicative of the levels of those skilled in the art to which the present disclosure pertains. All patents and publications are herein incorporated by reference to the same extent as if each individual publication was specifically and individually indicated as incorporated by reference.

The present disclosure illustratively described herein suitably may be practiced in the absence of any element or elements, limitation or limitations that are not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the present disclosure claimed. Thus, it should be understood that although the present disclosure has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A foaming agent comprising an amount of soy whey protein.

2. The foaming agent of claim 1, wherein the soy whey protein has a SSI of at least about 80% across a pH range of from 2 to 10 and a temperature of 25° C.

3. The foaming agent of claim 1, wherein the foaming agent comprises 100% by weight of soy whey protein.

4. The foaming agent of claim 1, further comprising at least one additional foaming agent.

5. The foaming agent of claim 4, wherein the at least one additional foaming agent is selected from the group consisting of mono- and diglycerides of fatty acids, esters of monoglycerides of fatty acids, propylene glycol monoesters, lecithin, hydroxylated lecithin, dioctyl sodium sulphosuccinate, sodium stearoyl-2-lactylate (SSL), calcium stearoyl lactylate (CSL), sorbitan monolaurate (Polysorbate 20), sorbitan monopalmitate (Polysorbate 40), sorbitan monostearate (Polysorbate 60), sorbitan monooleate (Polysorbate 80), sorbitan tristearate, stearyl citrate, and polyglycerol polyricinoleate (PGPR), albumin, gluten, casein, caseinate, dairy whey protein, and combinations thereof.

6. The foaming agent of claim 4, wherein the at least one additional foaming agent is sodium stearoyl-2-lactylate (SSL).

7. The foaming agent of claim 4, wherein the foaming agent comprises between about 5% to about 99.9% by weight of soy whey protein.

8. The foaming agent of claim 1, wherein the molecular weight of the soy whey protein is between about 8 kDa and about 50 kDa.

9. A food product comprising the foaming agent of claim 1.

10. The food product of claim 9, where in the food product has a pH of 2.0 to 8.0.

11. The food product of claim 8, which is a dessert product.

12. The food product of claim 9, wherein the dessert product is selected from the group consisting of pudding, whipped toppings, meringues, confections, cakes, frozen confections, frozen desserts, and combinations thereof.

13. The food product of claim 12 wherein the frozen dessert is a sorbet.

14. The food product of claim 9, which is a beverage product.

15. The food product of claim 14, wherein the beverage product is selected from the group consisting of milkshakes, smoothies, foam coffees, alcoholic beverages, and combinations thereof.

16. The food product of claim 9, wherein the foaming agent is present in the food product in an amount from about 0.02% to about 5% by weight of the food product.

17. The food product of claim 14, wherein the foaming agent is present in the food product in an amount from about 0.02% to about 2% by weight of the food product.

18. The food product of claim 14, wherein the foaming agent is present in the food product in an amount from about 0.02% to about 0.5% by weight of the food product.

19. A food product comprising a foaming agent, wherein the foaming agent comprises an amount of soy whey protein.

20. The food product of claim 19, wherein the food product further comprises water.

21. The food product of claim 19, wherein the food product further comprises a fat source.

22. The food product of claim 19, wherein the food product further comprises at least one additional foaming agent.

23. The food product of claim 22, wherein the at least one additional foaming agent is selected from the group consisting of mono- and diglycerides of fatty acids, esters of monoglycerides of fatty acids, propylene glycol monoesters, lecithin, hydroxylated lecithin, dioctyl sodium sulphosuccinate, sodium stearoyl-2-lactylate (SSL), calcium stearoyl lactylate (CSL), sorbitan monolaurate (Polysorbate 20), sorbitan monopalmitate (Polysorbate 40), sorbitan monostearate (Polysorbate 60), sorbitan monooleate (Polysorbate 80), sorbitan tristearate, stearyl citrate, and polyglycerol polyricinoleate (PGPR), albumin, gluten, casein, caseinate, dairy whey protein, and combinations thereof.

24. A method of making a food product comprising a foaming agent, the method comprising the steps of:
(1) combining the foaming agent with liquid to form an aerated mixture; and
(2) processing the aerated mixture into the desired food product, wherein the foaming agent comprises an amount of soy whey protein.

25. The method of claim 24, wherein the foaming agent further comprises at least one additional foaming agent.

26. The method of claim 24, wherein the foaming agent is present in the food product in an amount of from between about 0.02% and about 5% by weight.

27. The method of claim 24, wherein the food product is selected from the group consisting of a whipped topping, meringue, cake, sauce, soup, beverage, and combinations thereof.

28. A stabilized foaming agent comprising an amount of soy whey protein.

29. The stabilized foaming agent of claim 28, wherein the soy whey protein has a SSI of at least about 80% across a pH range of from 2 to 10 and a temperature of 25° C.

30. The stabilized foaming agent of claim 28, wherein the molecular weight of the soy whey protein is between about 8 kDa and about 50 kDa.

31. A food product comprising the stabilized foaming agent of claim 28.
